(19) United States
(12) Patent Application Publication
(10) Pub. No.: US 2015/0254782 A1
(43) Pub. Date: Sep. 10, 2015

(54) ELECTRONIC EXCHANGE AND COLLABORATION SYSTEM

(71) Applicant: Edward A. RIGGS-MILLER, Arlington, VA (US)

(72) Inventor: Edward A. Riggs-Miller, Arlington, VA (US)

(21) Appl. No.: 14/436,339

(22) PCT Filed: Oct. 17, 2013
(86) PCT No.: PCT/US2013/065367

§ 371 Date: Apr. 16, 2015

Related U.S. Application Data
(60) Provisional application No. 61/777,539, filed on Mar. 12, 2013.
(60) Provisional application No. 61/714,876, filed on Oct. 17, 2012.

(51) Int. Cl. G06Q 40/00; G06Q 10/10; G06Q 20/10

(52) U.S. Cl. CPC G06Q 40/12; G06Q 20/10; G06Q 10/101

(57) ABSTRACT

Systems, methods, and media for managing an exchange of capital between a producer of a creative work and investors are provided. A production plan for producing the creative work is received from the producer. The production plan includes a request for the capital. The production plan, including the request for the capital, is offered to the investors. Acceptances of the request for the capital are received from the investors. The acceptances include the requested capital for the production of the creative work. The capital that is received from the investors is transferred to the producer for producing the creative work. Revenue generated by the creative work is received and managed. At least a portion of the revenue is distributed to the investors in priority to the producer in accordance with a priority distribution scheme.

### CROSS-REFERENCE TO RELATED APPLICATION

The present application claims the benefit of each of U.S. Provisional Pat. Appl. No. 61/777,539, filed on Mar. 12, 2013, and U.S. Provisional Pat. Appl. No. 61/714,876, filed on Oct. 17, 2012. The disclosure of each of which, including the specification and figures, is incorporated herein by reference in its entirety.

### BACKGROUND

1. Field of the Disclosure

The present disclose generally relates to an electronic exchange and creative collaboration system. More particularly, the present disclosure relates to various systems, methods, and media for facilitating crowdsourcing and funding of creative works via the electronic exchange and creative collaboration system.

2. Background Information

People today have greater access to electronic devices than ever before. This has lead to increases in both the quantity and availability of creative works, and also has led to growth in both mainstream production channels as well as secondary production channels of the creative works. Through these increasing quantities and opportunities, however, it has become more difficult to obtain funding for the electronic works. Funding via the mainstream productions channels has become increasingly competitive. Moreover, also as a result of the increasing quantities and availability of creative works, larger funding budgets have become the norm. The larger budgets have increased the risk in providing funding and have necessarily further increased the difficulty in obtaining funding for the electronic works or productions.

As a result of the above-combination of factors, new and improved methods for funding the production and distribution of creative works are necessary.

### SUMMARY OF THE DISCLOSURE

The present disclosure, through one or more of its various aspects, embodiments, and/or specific features or sub-components, provides, inter alia, various systems, servers, methods, media, and programs for exchanging capital between a producer of a creative work and a plurality of investors.

According to a non-limiting embodiment of the present disclosure, a server manages an exchange of capital between a producer of a creative work and a plurality of investors. The server includes a network interface, a processor, and a memory. The memory includes instructions that, when executed by the processor, cause the processor to execute operations. The operations include receiving a production plan for producing the creative work from the producer via the network interface. The production plan includes a request for the capital. The operations also include offering the production plan including the request for the capital to the plurality of investors via the network interface, and receiving acceptances of the request for the capital from the plurality of investors via the network interface. The acceptances include the capital. The operations further include transferring the capital received from the plurality of investors to the producer for producing the creative work, and receiving and managing revenue generated by the creative work. At least a portion of the revenue is distributed to the plurality of investors in priority to the producer in accordance with a priority distribution scheme.

According to one aspect of the present disclosure, the revenue comprises an expenditure amount equal to the capital and a profit amount equal to the revenue which exceeds the capital. In this regard, the expenditure amount comprises the portion of the revenue which is distributed to the plurality of investors in priority to the producer in accordance with the priority distribution scheme.

According to another aspect of the present disclosure, the expenditure amount is entirely distributed to the plurality of investors in priority to the producer by the priority distribution scheme.

According to yet another aspect of the present disclosure, the priority distribution scheme is a first-in, first-out distribution scheme in which the expenditure amount is distributed to the plurality of investors in an order of the acceptances of the request for the capital.

According to still another aspect of the present disclosure, the profit amount is distributed to the plurality of investors and the producer in accordance with a profit distribution scheme different than the priority distribution scheme.

According to an additional aspect of the present disclosure, the profit distribution scheme includes an option by which each of the plurality of investors may forego any distribution of the profit amount under the profit distribution scheme for a predetermined period of time in exchange for predetermined rights in the creative work.

According to yet another aspect of the present disclosure, the production plan for producing the creative work includes a plurality of production stages. Each of the plurality of production stages is associated with a portion of the capital, and the capital is transferred to the producer in accordance with a completion of each of the plurality of production stages.

According to still another aspect of the present disclosure, the operations even further include receiving updates for the plurality of production stages from the producer via the network interface, making the updates for the plurality of production stages available to the plurality of investors via the network, and reimbursing any unused portion of the capital of any unsatisfied investors in response to receiving a request from the unsatisfied investors.

According to an additional aspect of the present disclosure, the operations include reimbursing any unused portion of the capital to the plurality of investors in response to a failure of the producer to complete one of the plurality of production stages.

According to another aspect of the present disclosure, the unused portion of the capital is reimbursed to the plurality of investors in accordance with a reimbursement priority scheme by which at least some of the unused portion of the capital is reimbursed to a first investor in priority to a second investor.

According to yet another aspect of the present disclosure, the production plan includes the request for the capital from a predetermined number of users. Each of the predetermined number of users is requested to contribute the capital in an equal amount.

According to still another aspect of the present disclosure, the production plan includes the request for the capital for the creative work and further includes a second request for second capital for a plurality of creative works. In this regard, the acceptances from the plurality of investors comprise first acceptances of the request for the capital for the creative work and second acceptances of the second request for the second capital for the plurality of creative works. The priority scheme distributes the portion of the revenue to the plurality of investors from which second acceptances are received in priority to the plurality of investors from which the first acceptances are received.

According to an additional aspect of the present disclosure, the operations include making the creative work available to the plurality of investors and to viewing users via the network interface for generating the revenue.

According to another aspect of the present disclosure, the creative work is made available to the plurality of investors for one of a predetermined period of time and a predetermined number of viewings via the network without charge after a release of the creative work.

According to another non-limiting embodiment of the present disclosure, a method for managing an exchange of capital between a producer of a creative work and a plurality of investors is provided. The method includes receiving, via a network interface, a production plan for producing the creative work from the producer. The production plan includes a request for the capital. The method also includes offering, via the network interface, the production plan including the request for the capital to the plurality of investors, and receiving, via the network interface, acceptances of the request for the capital from the plurality of investors. The acceptances include the capital. The method further includes transferring the capital received from the plurality of investors to the producer for producing the creative work, and receiving and managing, by a processor, revenue generated by the creative work. At least a portion of the revenue being distributed to the plurality of investors in priority to the producer in accordance with a priority scheme.

According to an aspect of the present disclosure, the revenue comprises an expenditure amount equal to the capital and a profit amount equal to the revenue which exceeds the capital. In this regard, the expenditure amount comprises the portion of the revenue which is distributed to the plurality of investors in priority to the producer in accordance with the priority distribution scheme.

According to another aspect of the present disclosure, the expenditure amount is entirely distributed to the plurality of investors in priority to the producer by the priority distribution scheme.

According to yet another non-limiting embodiment of the present disclosure, a non-transitory computer readable medium includes an executable set of instructions for managing an exchange of capital between a producer of a creative work and a plurality of investors. The executable set of instructions, when executed by a processor, causes the processor to execute operations including receiving a production plan for producing the creative work from the producer. The production plan includes a request for the capital. The operations also include offering the production plan including the request for the capital to the plurality of investors, and receiving acceptances of the request for the capital from the plurality of investors. The acceptances include the capital. The operations even further include transferring the capital received from the plurality of investors to the producer for producing the creative work, and receiving and managing revenue generated by the creative work. At least a portion of the revenue is distributed to the plurality of investors in priority to the producer in accordance with a priority scheme.

According to an aspect of the present disclosure, the revenue comprises an expenditure amount equal to the capital and a profit amount equal to the revenue which exceeds the capital. In this regard, the expenditure amount comprises the portion of the revenue which is distributed to the plurality of investors in priority to the producer in accordance with the priority distribution scheme.

According to another aspect of the present disclosure, the expenditure amount is entirely distributed to the plurality of investors in priority to the producer by the priority distribution scheme.

### BRIEF DESCRIPTION OF THE DRAWINGS

The present invention is further described in the detailed description which follows, in reference to the noted plurality of drawings, by way of non-limiting examples of preferred embodiments of the present invention, in which like characters represent like elements throughout the several views of the drawings.

FIG. 1 illustrates an exemplary schematic of an electronic exchange and collaboration system.

FIG. 2 illustrates a further exemplary schematic an electronic exchange and collaboration system.

FIG. 3 illustrates an exemplary schematic of a home page of an electronic exchange and collaboration system.

FIG. 4 illustrates an exemplary schematic of a table of contents an electronic exchange and collaboration system.

FIG. 5 illustrates an exemplary schematic of a general function of an electronic exchange and collaboration system.

FIG. 6 illustrates an exemplary schematic of a scenario of an electronic exchange and collaboration system.

FIG. 7 illustrates an exemplary set of operations of an electronic exchange and collaboration system.

FIG. 8 illustrates an exemplary schematic of a web portal of an electronic exchange and collaboration system.

FIG. 9 illustrates an exemplary schematic of a user dashboard of an electronic exchange and collaboration system.

FIG. 10 illustrates an exemplary schematic of a project information form of an electronic exchange and collaboration system.

FIG. 11 illustrates an exemplary schematic of a project summary details form for a producer of an electronic exchange and collaboration system.

FIG. 12 illustrates an exemplary schematic of a project summary details form for an investor of an electronic exchange and collaboration system.

FIG. 13 illustrates an exemplary schematic of a basic logical delivery and distribution process of an electronic exchange and collaboration system.

FIG. 14 illustrates a further exemplary schematic of a logical delivery and distribution process of an electronic exchange and collaboration system.

FIG. 15 illustrates an exemplary schematic of a logical portal process of an electronic exchange and collaboration system.

FIGS. 16A, 16B, 16C, 16D, and 16E illustrate exemplary schematics of distribution schemes of an electronic exchange and collaboration system.

FIG. 17 illustrates an exemplary set of operations of an electronic exchange and collaboration system.

FIG. 18 illustrates an exemplary schematic of a set of functions and scenarios of an electronic exchange and collaboration system.

FIG. 19 illustrates an exemplary schematic of logical functions of an electronic exchange and collaboration system.

FIG. 20 illustrates an exemplary schematic of a logical block structure and functions of an electronic exchange and collaboration system.

FIG. 21 illustrates an exemplary schematic of a functions list of an electronic exchange and collaboration system.

FIG. 22 illustrates an exemplary schematic of a media sharing function of an electronic exchange and collaboration system.

FIG. 23 illustrates an exemplary schematic of a video asset tracking process of an electronic exchange and collaboration system.

FIG. 24 illustrates an exemplary explanation of a video asset tracking process of an electronic exchange and collaboration system.

FIG. 25 illustrates an exemplary schematic of a media asset tracking process of an electronic exchange and collaboration system.

### DETAILED DESCRIPTION

The present disclosure, through one or more of its various aspects, embodiments and/or specific features or sub-components, is thus intended to bring out one or more of the advantages as specifically noted below.

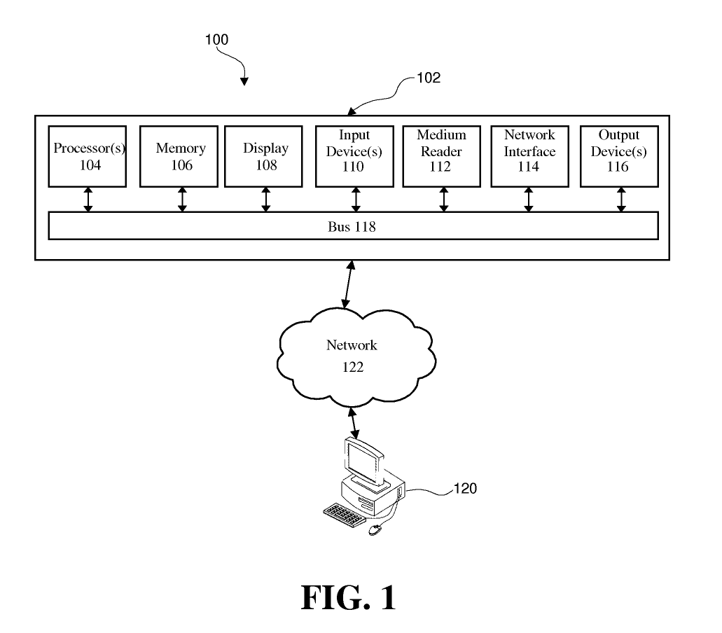

FIG. 1 is an exemplary system 100 for use in accordance with the embodiments described herein. The system 100 manages an exchange of capital between a producer of a creative work and a plurality of investors. The producer may offer a production plan for the creative work that includes a request for capital, whereupon each of the investors may agree to contribute a portion of the capital in exchange for a royalty funding interest in the creative work. In this regard, the system 100 includes a means for distributing the creative work which is produced with the investors' contributions of capital, and for providing the investors with royalties derived by the creative work in accordance with their contributions.

Such a system 100 is not a rich funding model where only a few with sufficient money can participate, which would cause the masses to stop participating due to limited stake in the process. Instead, the system 100 encourages mass funding of creative works which provides for professional productions while diminishing the necessity of acquiring advertising and promotional funding. The mass funding further promotes and automates the marketing and distribution of such creative works. Moreover, such a system 100 enables producers to retain rights in their creative works without bearing the financial burden of production, thereby promoting and incentivizing creativity.

The system 100 may include a computer system 102, which is generally indicated. The computer system 102 may operate as a standalone device or may be connected to other systems or peripheral devices. For example, the computer system 102 may include, or be included within, any one or more computers, servers, systems, communication networks or cloud environment.

The computer system 102 may operate in the capacity of a server in a network environment, or the in the capacity of a client user computer in the network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 102 is illustrated, addition embodiments may include any collection of systems or sub-systems that individually or jointly execute instructions or perform functions.

As illustrated in FIG. 1, the computer system 102 may include at least one processor 104, such as, for example, a central processing unit, a graphics processing unit, or both. The computer system 102 may also include a computer memory 106. The computer memory 106 may include a static memory, a dynamic memory, or both. The computer memory 106 may additionally or alternatively include a hard disk, random access memory, a cache, or any combination thereof. Of course, those skilled in the art appreciate that the computer memory 106 may comprise any combination of known memories or a single storage.

As shown in FIG. 1, the computer system 102 may include a computer display 108, such as a liquid crystal display, an organic light emitting diode, a flat panel display, a solid state display, a cathode ray tube, a plasma display, or any other known display.

The computer system 102 may include at least one computer input device 110, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 and a network interface 114. Furthermore, the computer system 102 may include any additional devices, components, parts, peripherals, hardware, software or any combination thereof which are commonly known and understood as being included with or within a computer system, such as, but not limited to, an output device 116. The output device 116 may be, but is not limited to, a speaker, an audio out, a video out, a remote control output, a printer, or any combination thereof.

Each of the components of the computer system 102 may be interconnected and communicate via a bus 118. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, or any other network commonly known and understood in the art. The network 122 is shown in FIG. 1 as a wireless network. However, those skilled in the art appreciate that the network 122 may also be a wired network.

The additional computer device 120 is shown in FIG. 1 as a personal computer. However, those skilled in the art appreciate that, in alternative embodiments of the present application, the device 120 may be a laptop computer, a tablet device, a personal digital assistant, a mobile device, a palmtop computer, a desktop computer, a smartphone, a communications device, a wireless telephone, a personal trusted device, a web appliance, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

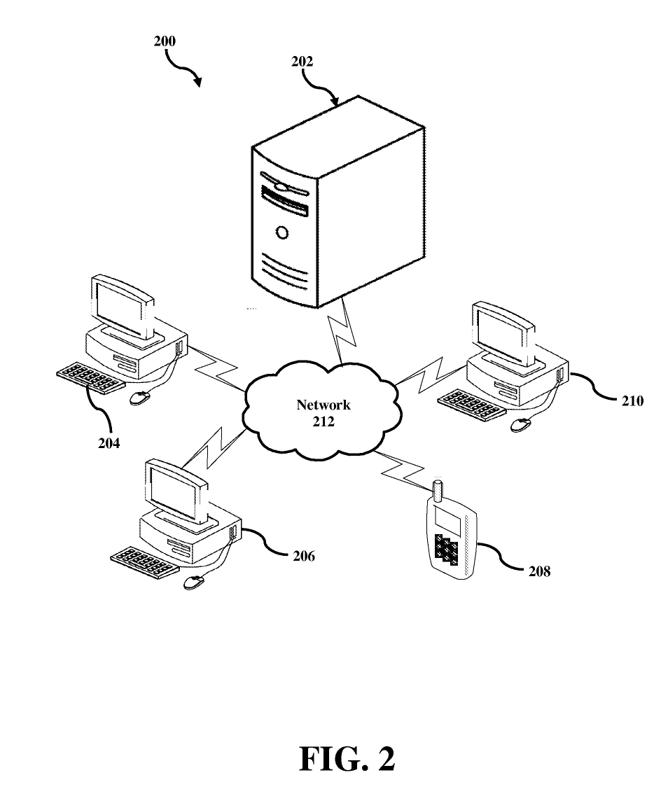

An exemplary schematic of the system 100 is generally shown at 200 in FIG. 2. The system 200 is shown in FIG. 2 as including a computer server 202, and various electronic devices 204, 206, 208, 210. The computer server 202 and the electronic devices 204, 206, 208, 210 are interconnected via a network 212.

The computer server 202 is shown in FIG. 2 as comprising a server. Nevertheless, the computer server 202 may be or be similar to the computer system 102 of FIG. 1. The computer server 202 may include any combination of the various components discussed with respect to the computer system 102, and may also include any additional or alternative components of a server which are generally known and understood in the art.

The electronic devices 204, 206, 208, 210 are shown in FIG. 2 as comprising desktop computers and a cellular telephone. Nevertheless, the electronic devices 204, 206, 208, 210 are not limited to being desktop computers and cellular telephones. The electronic devices 204, 206, 208, 210 may additionally or alternatively be any device which is capable of communicating with the computer server 202 via the network 212. For example, the electronic devices 204, 206, 208, 210 may be or be similar to the computer server 102 or the one or more additional computer devices 102, as described with respect to FIG. 1. In this regard, the electronic devices 204, 206, 208, 210 may comprise any of the non-limiting and exemplary devices discussed with respect the computer server 102 and/or the one or more additional computer devices 102, and include any combination of the various components discussed with respect thereto.

The network 212 is shown as being similar to the network 122 of FIG. 1. In this regard, the network 212 may include any of the non-limiting and exemplary networks discussed with respect to the network 122 of FIG. 1, and may additionally or alternatively include any other network that is known and understood in the art. The network 212 may comprise any means or medium through which the computer server 202 and the electronic devices 204, 206, 208, 210 may communicate.

The system 200 of FIG. 2 may provide an Electronic Exchange and Collaboration System (hereinafter EECS). The computer system may provide the EECS, which is accessible by the electronic devices 204, 206, 208, 210 via the network 212. The electronic devices 204, 206, 208, 210 may access the EECS by accessing a website, a web portal, or a specific uniform resource locator (URL) via the Internet. In additional or alternative embodiments, the electronic devices 204, 206, 208, 210 may access the EECS by executing or running an application or a program. The EECS is generally shown and described hereinafter with respect to a serious of webpages, windows, and schematics for convenience. Nevertheless, those of ordinary skill in the art understand that EECS is not limited to such embodiments and appreciate that the electronic devices 204, 206, 208, 210 may access or execute the EECS by any additional or alternative means or methods which are known and understood in the art.

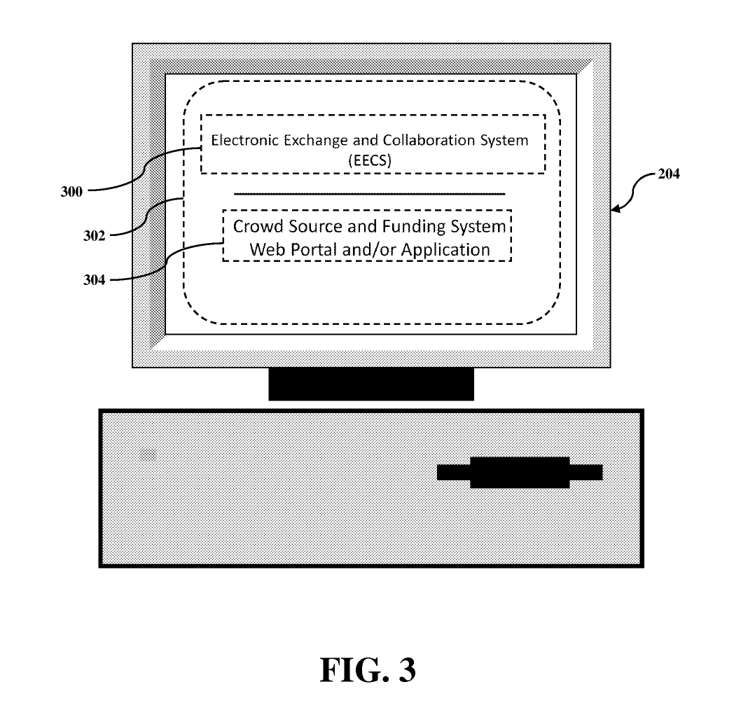

An exemplary Home, Main, Index, or Title page (hereinafter “Home page 302”) of an EECS 300 is generally indicated at 302 in FIG. 3. The Home page 302 may include any combination of graphics, text, video, and sound data. In this regard, as with any of the pages or screenshots described herein, the Home page 302 may be accessible by the electronic devices 204, 206, 208, 210 via the network 212 and may comprise any combination of graphics, text, video, and sound data. Those of ordinary skill in the art appreciate the pages and screenshots shown and described herein are merely exemplary and that the scope of the present disclosure is not limited to the specifically described or shown pages or screenshots.

For example, as shown in FIG. 3, the Home page 302 may list various functions or systems which are provided by the EECS 300, such as a Crowd Source and Funding System 304. The Crowd Source and Funding System 304 is described in more detail hereinafter. As with any of the functions or systems described herein, the Crowd Source and Funding System 304 may be included within the EECS 300 or may comprise a separate and distinct function or system.

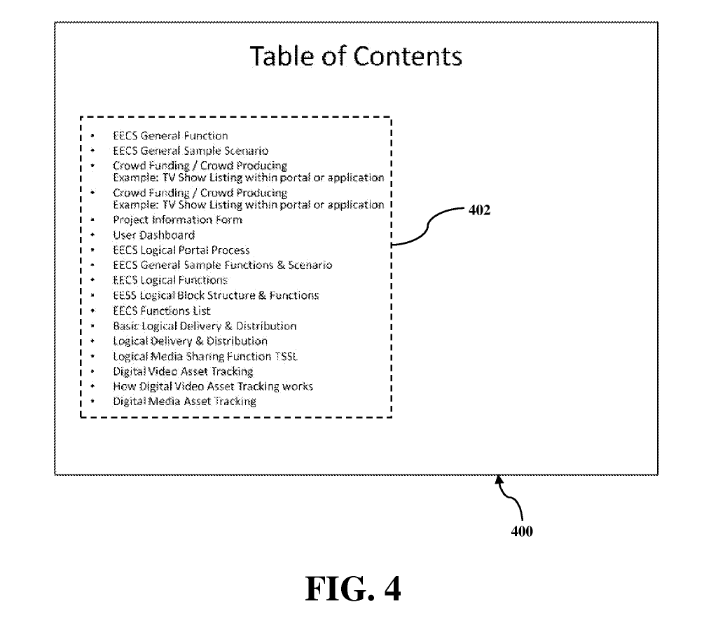

An exemplary Table of Contents schematic of the EECS 300 is generally indicated at 400 in FIG. 4. The Table of Contents schematic 400 is shown in FIG. 4 as including a plurality of listed functions 402. In this regard, it is to be appreciated that the listed functions 402 are merely exemplary and are not limiting, exclusive, or exhaustive. The EECS 300, as well as the additional systems and functions described herein, may comprise any combination of functions, shown or not shown, without departing from the present disclosure.

When accessing the EECS 300, the electronic devices 204, 206, 208, 210 may function with respect to a producer of a creative work, an investor in the creative work, or a viewer of the creative work. In certain embodiments of the present application, any of the electronic devices 204, 206, 208, 210 may perform any of the above-mentioned user functions, e.g., producing, investing, and viewing. However, in alternative embodiments, of the present application, any of the electronic devices 204, 206, 208, 210 may be limited to performing any one or less than all of the above-mentioned user functions. The electronic devices 204, 206, 208, 210 may be limited to the user functions which they perform based on any known or understood criteria, such as, but not limited to, payment, registration, membership status, and account activity in the EECS 300.

Notwithstanding the above, for simplicity, the electronic device 206 is referred to hereinafter as a producer or a production device, which produces the creative work. The electronic device 208 is referred to hereinafter as an investor or an investment device, which invests in the production of the creative work. The electronic device 210 is referred to hereinafter as a viewer or a viewer device, which views the creative work. The electronic device 204 is generally referred to hereinafter generically as a user or a user device, which merely accesses the EECS 300. Nevertheless, it is to be known and understood that the electronic devices 204, 206, 208, 210 are not limited to performing any single user function but may perform any combination of the user functions described herein.

While the specification may refer to either a producer or a production device as the electronic device 206, it is to be generally understood that these terms may be interchangeable. The term production device should be interpreted as being limited solely to the physical, tangible electronic device 206, while the term producer should be interpreted as describing both or either of the user of the electronic device 204 and the physical, tangible electronic device 204 itself. A same rationale and interpretation should apply for each of the investor and the investment device in regards to the electronic device 208, the viewer and the viewer device in regards to the electronic device 210, and the user and the user device in regards to the electronic device 204.

In addition to the above, each of the producer or the production device, the viewer or the viewer device, and the user or the user device are generally referred to herein in singular form. Nevertheless, it should be known and understood that the EECS 300 generally comprises a plurality of each of the above-listed entities. The investor and investment device are generally referred to herein as being in plural form. Nevertheless, it should also be known and understood that there may be a single investor or investment device.

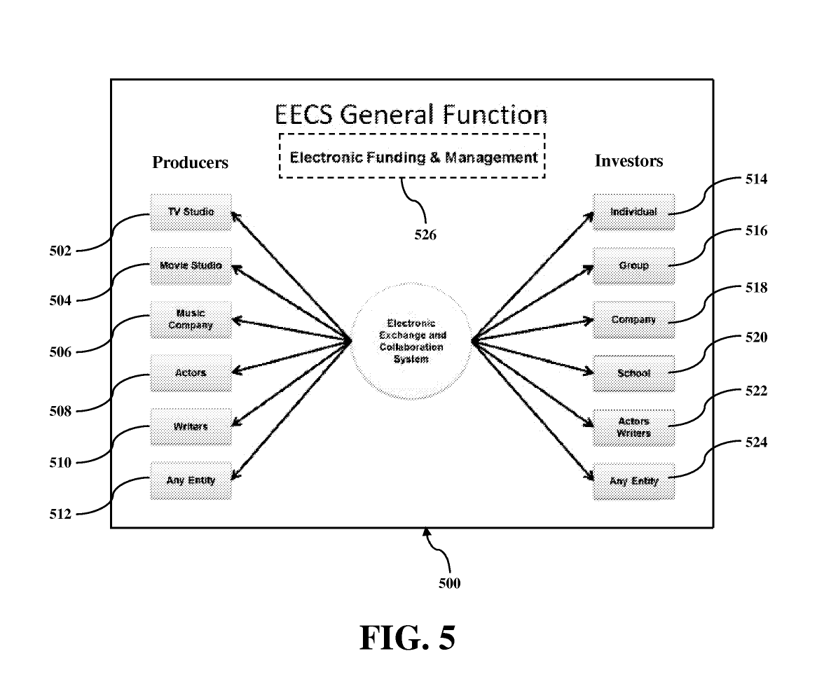

An exemplary General Function schematic of the EECS 300 is generally indicated at 500 in FIG. 5. The General Function schematic 500 lists exemplary entities which may control or comprise the production device 206 at 502-512. For example, the production device 206 may be controlled by or comprise a television studio 502, a movie studio 504, a music company 506, an actor 508, a writer 510, or any other entity 512 which authors or creates a creative work. The General Function schematic 500 also lists exemplary entities which may control or comprise the production device 206 at 514-524. For example, the production device 206 may be controlled by or comprise, but is not limited to being controlled by or comprising, an individual 514, a group 516, a company 518, a school 520, an actor or writer 522, or any other entity 524. Of course, the production device 206 and the production device 206 are not limited to being controlled by or comprising the shown entities. Those of ordinary skill in the art appreciate that the production device 206 and the production device 206, as well as any of the electronic devices 204, 206, 208, 210, may be controlled by or comprise any additional entity or combination of entities in addition to or alternatively to the above.

The General Function schematic 500 shows an exemplary Electronic Funding & Management function 526 of the EECS 300. The Electronic Funding & Management function 526 may be the same or similar to the crowd source and funding application referred to in FIG. 3. In principal, the Electronic Funding & Management function 526 of the EECS 300 provides at least two parties or entities, e.g., the producer 206 and the investor 208, with a way to fund entertainment, media, business projects, or any other creative work via a web portal, application, or program.

The EECS 300 allows the parties or entities to fund and benefit based on the criteria or offerings built into the EECS 300 and requirements of the creative work or project. The EECS 300 is not only a system, but a process designed to create and facilitate an exchange limited only by the creative work or project requirements. The creative work or project may comprise a single creative work or project, or may comprise a group or series of creative works or projects.

The EECS 300 allows a user to order a specific program or group of programs and to choose, via the Electronic Funding & Management function 526, whether or not they want to invest in and/or profit from the creative work or project. The EECS 300 controls a for-profit exchange primarily based around original content, projects, or entertainment produced by the producer 206 and investors 208 which have funded the production of the original content, project, or entertainment. In this regard, the EECS 300 can be used to distribute the original content, projects, or entertainment as well as other licensed and unlicensed non-original content for viewing and for profit. The EECS 300 manages and supports any combination of production, funding, profiting, and contributing of creative works.

In any event, the EECS 300 enables the producer 206 and the investors 208 to exchange, subscribe, deliver, or collaborate on any type of information for the purpose of creating and funding projects. The parties can exchange data, transactions, media, concepts, designs, imagery, and any other information limited only by any project requirements. In its simplest function, the EECS 300 allows the producer 206 and the investors 208 to offer entertainment projects for funding and to fund the entertainment projects, respectively. The EECS 300 also provides the flexibility to allow contributions of any sort to any project one chooses to participate in while allowing users to profit from the entertainment projects they are producing or funding. The EECS 300 further provides an information exchange platform or media repository which allows for the finished entertainment projects to be delivered to each viewer 210. The finished entertainment projects may be delivered to each viewer 210 via the network 212 by any known and understood methods in the art.

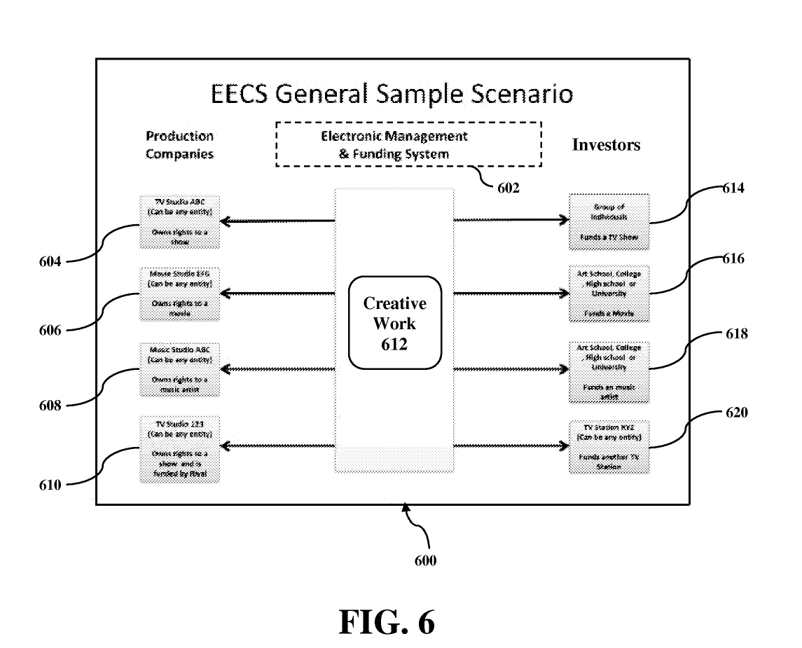

A Sample Scenario of the EECS 300 is generally indicated at 600 in FIG. 6. The Sample Scenario 600 shows examples of the Electronic Funding & Management function 526 which are executed by an Electronic Management & Funding System 602. The Electronic Management & Funding System 602 may comprise, for example, the computer system as described with respect to FIG. 1. The Sample Scenario 600 shows various production companies 604-610 as producers 208 which each produce a creative work 612. The production companies 604-610 may be, for example, a TV Studio ABC 604, a Movie Studio EFG 606, a Music Studio ABC 608, and a TV Studio 123 610.

A single creative work 612 is shown in the Sample Scenario 600 as being produced by the production companies 604-610. Nevertheless, it is to be understood that each of the production companies 604-610 may individually produce a creative work 612. For example, as generally shown by FIG. 6, the TV Studio ABC 604 may produce a show, the Movie Studio EFG 606 may produce a movie, the Music Studio ABC 608 may produce a music artist, and the TV Studio 123 610 may produce a show. The creative work 612 should be understood to include any artistic work, project, or offering, such as, but not limited to, a video, an audio, a textual, or a live composition or production. In embodiments of the present application, the production companies 604-610 may directly produce the creative work 612. However, it should be understand that the production companies 604-610 may be indirectly involved in the production of the creative work 612. In this regard, each of the production companies 604-610 should be understood to comprise any entity or entities which are directly or indirectly involved in the production of the creative work 612.

As shown in the Sample Scenario 600 of FIG. 6, the production companies 604-610 are each indicated as owning the rights in the creative work 612. This encourages producers 206 to use the EECS 300 and also simplifies the functionality and role of the EECS 300. That is, it is not necessary for the EECS 300 to pay any licensing fees or royalties for distribution or sharing of the content. Nevertheless, in further embodiments of the EECS 300, it is to be understood that the EECS 300 may obtain partial or full distribution, ownership, and/or other rights in the creative work 612. Moreover, in even further embodiments of the EECS 300 as discussed in more detail below, it is to be understood that the producer 206 may provide certain ownership, distribution, or other rights to each investor 208. The rights provided to the investor 208 may be outlined or set forth in a production plan for the creative work which is offered by the producer 206.

The Sample Scenario 600 of the EECS 300 further shows various investors 614-620. Each of the investors 614-620 is shown as being a single investor, but the investors 614-620 may comprise a plurality of individual investors. The investors 614-620 each fund one of the production companies 604-610 in the production of the creative work 612. In this regard, FIG. 6 generally shows a one-to-one relationship between the production companies 604-610 and the investors 614-620 to demonstrate a basic funding, functionality, collaboration and communication process of the Electronic Funding & Management function 526. A basic function the EECS 300 allows the production companies 604-610 and investors 614-620 to fund and/or offer entertainment projects for funding or contribution of any sort.

For example, as shown in FIG. 6, the Group of Individuals 614 funds production of the show by the TV Studio ABC 604. The Art School, College, High School, or University 616 funds the production of the movie by the Movie Studio EFG 606. The Art School, College, High School, or University 618 funds the production of the music artist by the Music Studio ABC 608. Finally, the TV Station XYZ 620 funds the production of the show by the TV Studio 123 610. As generally shown by FIG. 6, any of the 614-620 may fund any of the production companies 604-610. That is, TV Station XYZ 620 may even fund the production of a show by rival TV Studio 323. In this regard, the investors 614-620 may be anonymous to the production companies 604-610. Alternatively, the investors 614-620 may be known to the production companies 604-610.

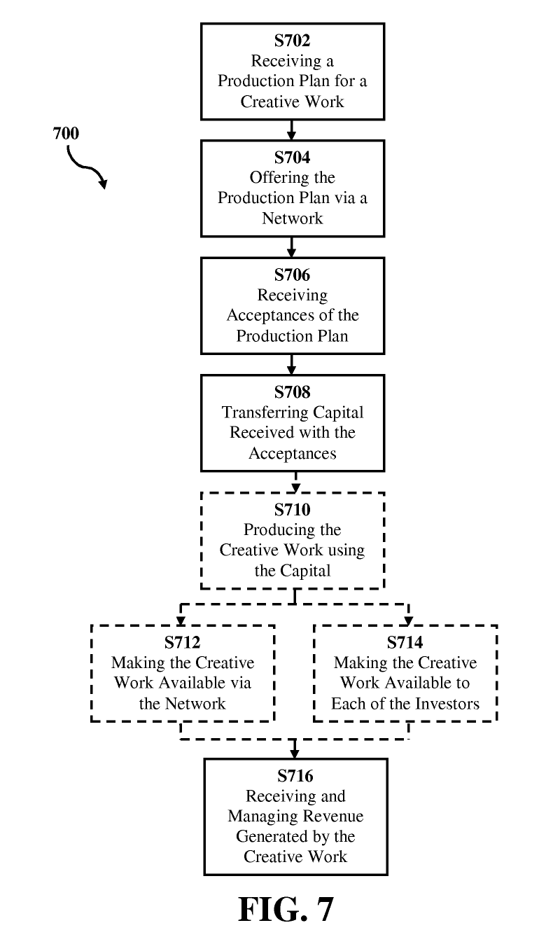

An exemplary embodiment of the Electronic Funding & Management function 526 of the EECS 300 is generally shown in FIG. 7. The exemplary embodiment includes operations for managing an exchange of capital between a producer 206 of a creative work and a plurality of investors 208. The operations are generally shown at 700 in FIG. 7 and may be managed by the computer server 202 as shown in FIG. 2. The computer server 202 may include a memory, such as the computer memory 106 as described with respect to FIG. 1, that stores instructions that are executable by a processor, such as the at least one processor 104 as described with respect to FIG. 1, for causing the processor to execute the operations. The producer 206 may be controlled by or comprise the production device 206 as shown in FIG. 2. The investors 208 may each be controlled by or comprise the investment device 208 as shown in FIG. 2.

When the processor of the computer server 202 executes the instructions included within the memory, the processor may execute the operations including receiving a production plan for producing the creative work from the producer 206 at S702. The production plan may be received from the producer 206 by a network interface, such as the network interface 114 as described with respect to FIG. 1. The production plan may be received via a network 212, such as the network 122 as described with respect to FIG. 1. In this regard, the production plan may be received by the network interface through a web portal, an application, or a program.

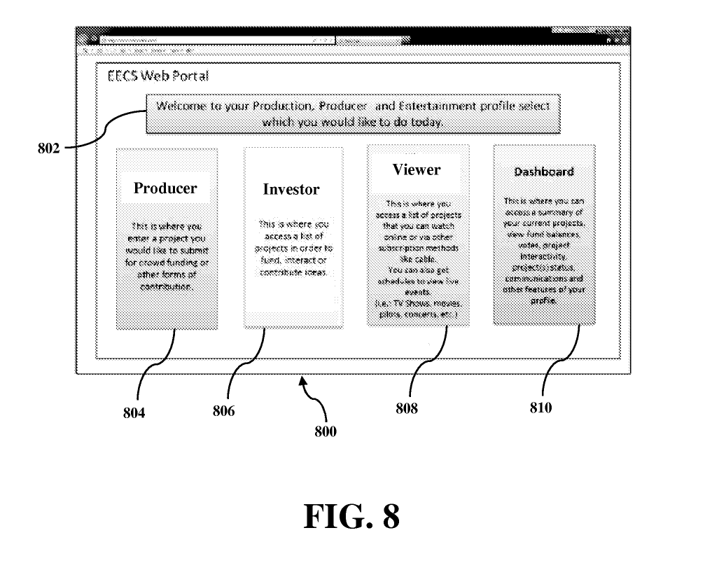

An exemplary embodiment of a Web Portal of the EECS 300 through which the producer 206 may submit the production plan is generally indicated at 800 in FIG. 8. The Web Portal 800 allows the users 204 to view entertainment on demand via different sources. The entertainment may be viewed based on user-demand or based on scheduled, third party, or private listings. The Web Portal 800 may include a Greeting or Welcome Message 802. The Web Portal 800 may also include a Producer Section 804 through which the producer 206 may submit a creative work or production plan for crowd funding or for other forms of contribution. The Web Portal 800 may further include an Investor Section 806 through which the investors 208 may access a list of creative works in order to determine creative works to fund, interact with, or contribute ideas to. The Web Portal 800 may even further include a Viewer Section 808 through which viewers may access a list of creative works that they can view or otherwise interact with. Finally, the Web Portal 800 may also include a Dashboard Section 810 through which a user may access his or her account information.

The Web Portal 800 of FIG. 8 is merely exemplary and intended to demonstrate how a user may access information in order to create or produce a creative work or project, to fund a creative work or project, or to access information relative to funding, viewing, or managing creative works or projects. The Web Portal 800 merely demonstrates the possibilities of the EECS 300 in its most basic form, and those of ordinary skill in the art should appreciate that the exemplary Web Portal 800 may be modified to suit any design or development requirements from users or projects.

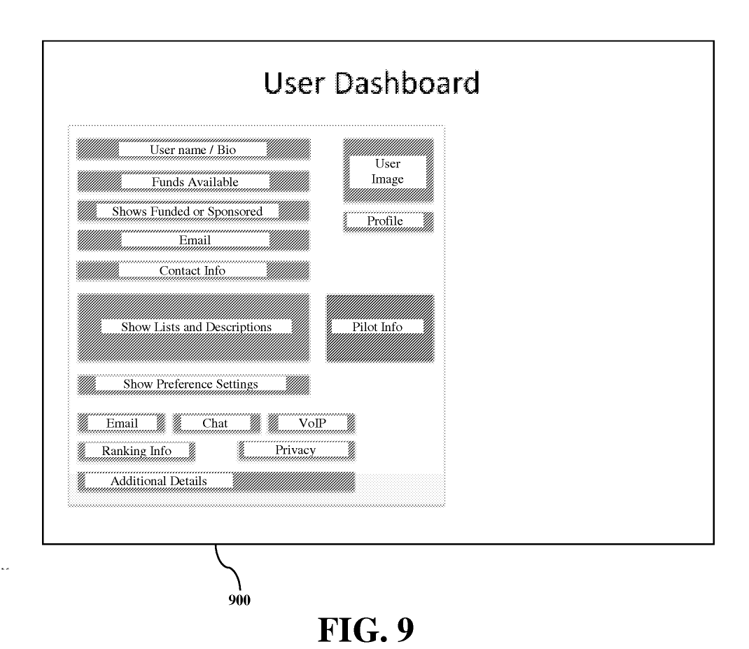

An exemplary User Dashboard is generally indicated at 900 in FIG. 9. The User Dashboard 900 is a sample of what the user sees from a profile and project standpoint once they have logged into the web portal, application, and/or program of the EECS 300. Each of the users may have a same User Dashboard 900 regardless of whether the user is a producer 206, investor 208, or viewer 210. Alternatively, the User Dashboard 900 may be customized depending on whether the user is classified as a producer 206, investor 208, or viewer 210. The user may be classified based on a frequency of use, a most recent use, a user preference setting, or any other classification method which is understood in the art.

The User Dashboard 900 may provide a user with a summary of his or her current projects, a view of his or her balances, votes, any project interactivity, any project statuses, messages, communications, or any other features of the user's profile. Of course, those of ordinary skill in the art appreciate that the above-listed items of information are merely exemplary and are not exclusive or exhaustive. In this regard, additional items of information are shown in the User Dashboard 900 of FIG. 9. The EECS 300 may provide standardized information on the User Dashboard 900 of each user, or the EECS 300 may enable users to present any information in any way that the user selects in order to interact with projects, users, the web portal, or other applications.

Once again, with reference to FIG. 7, the processor may execute the operations including receiving a production plan for producing the creative work from the producer 206 at S702. The production plan may be received via the Web Portal 800 of FIG. 8.

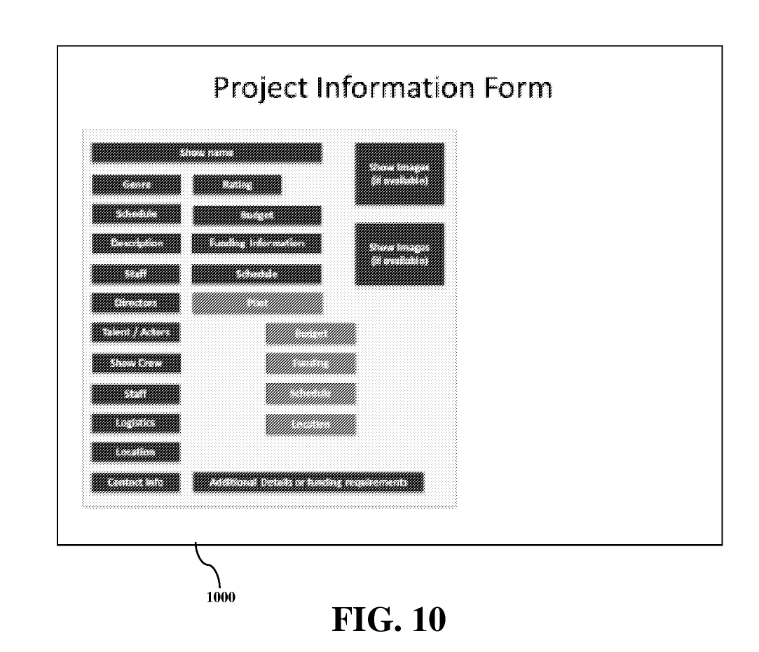

The production plan may comprise a Project Information Form, as generally indicated at 1000 of FIG. 10. The Project information Form 1000 is merely exemplary and shows various types of information of which the production plan may comprise. The Project information Form 1000 may show what a producer 206 and/or investors 208 may see prior to engaging a project or creative work which interests them. The various types of information are not exclusive or exhaustive, and should not be considered limiting. The EECS 300 may store the various types of information from the Project Information Form 1000 in a database such that the information may be presented to and searchable by the users of the EECS 300 via the web portal, the application, and/or the program.

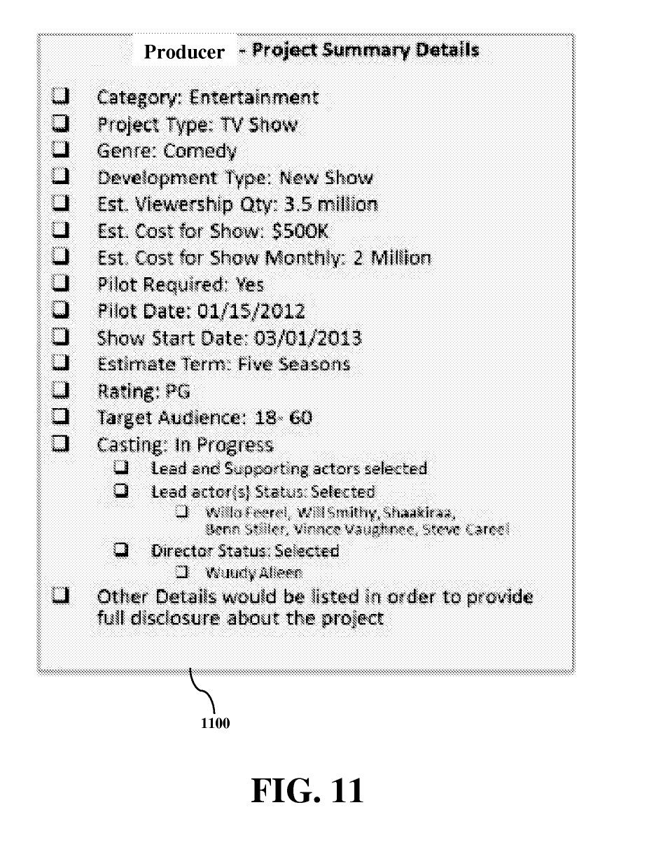

A further example of the production plan is shown as a Producer—Project Summary Details Form at 1100 in FIG. 11. The Producer—Project Summary Details Form 1100 is an additional or alternative production plan that demonstrates a summary of what a producer 206 may list in order to get funding for the production of the creative work or project. Of course, those of ordinary skill in the art appreciate that the Producer—Project Summary Details Form 1100 is merely exemplary and that it may be modified to suit any design or development requirements of the producer 206, creative work, or project.

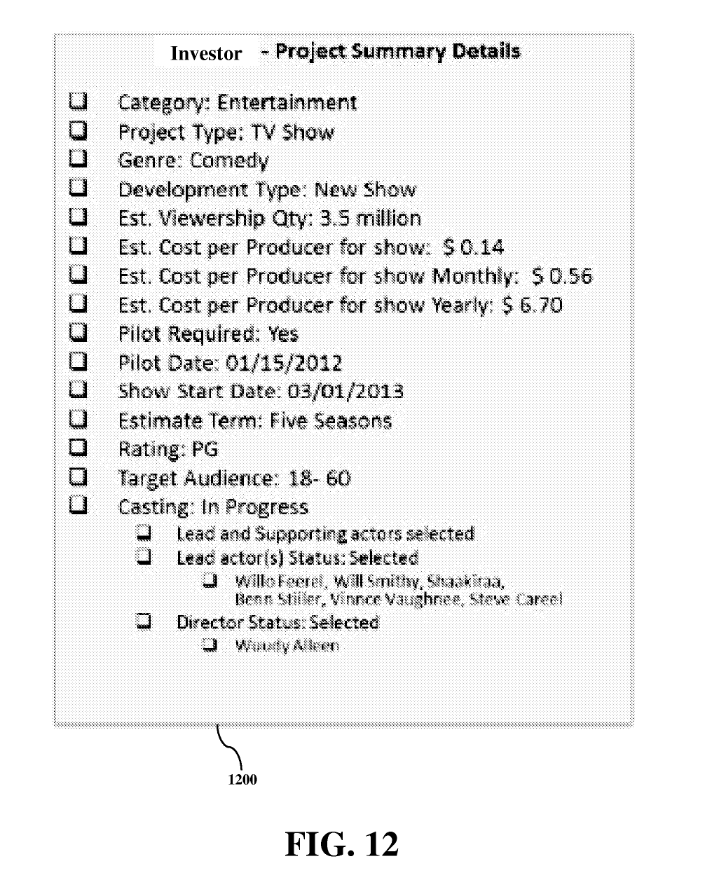

An Investor—Project Summary Details Form is generally indicated at 1200 in FIG. 12. The Investor—Project Summary Details Form 1200 is an additional or alternative production plan that demonstrates a summary of what an investor 208 may see prior to engaging or committing to funding a creative work or project. The Investor—Project Summary Details Form 1200 may be provided for convenience of the investors 208 to enable the investors 208 to more quickly gauge interest. In this regard, the Investor—Project Summary Details Form 1200 may be provided by the producer 206 or created by the EECS 300 in addition to, or as an alternative to, any of the Project information Form 1000 and the Producer—Project Summary Details Form 1100. These forms are merely provided as examples and it is to be understood that they are not limiting.

In the embodiment of the Electronic Funding & Management function 526 shown in FIG. 7, the production plan is solely limited to including a request for the capital for the production of the creative work. The request may comprise a fixed amount of the capital that is solely necessary for the production of the creative work, or the request may include additional amounts in excess to an estimated production cost of the creative work. The additional amounts may comprise an overage allowance that is set by the producer 206, or the additional amounts may include an overage allowance that is set by a predetermined method of the EECS 300. The additional amounts may additionally or alternatively include any service fees or additional charges of the EECS 300 in further embodiments. Those of ordinary skill in the art will appreciate that the request for capital may comprise any prescribed or set fees or allowances which are generally associated with productions, projects, or even electronic membership and content distribution systems.

The request for capital may specify a predetermined number of investors 208 which are necessary for satisfying the request. In this regard, each of the predetermined number of investors 208 may be limited to contributing a predetermined amount. The predetermined amount may be set equally amongst each of the predetermined number of investors 208 to provide each of the investors 208 with an equal interest in the production of the creative work. This will further encourage and promote mass funding of the creative work, thereby strengthen and broadening the brand and scope of the EECS 300. In such embodiments, each of the investors 208 may further be limited to contributing to only a single, predetermined amount in order to ensure that each of the investors 208 has the equal interest and to even further encourage and promote mass funding.

In even further embodiments of the operations 700 of the Electronic Funding & Management function 526 shown in FIG. 7, any amounts of the request for capital which may be contributed by the investors 208 may be set or established by the EECS 300. For example, the EECS 300 may limit or set a maximum contribution amount of an investor 208 bases on a total amount of the request for the capital. Additionally or alternatively, the EECS 300 may limit the amount that the investors 208 may contribute based on the investors 208 themselves. For example, an investor 208's limit may be set in accordance with a rating or contribution history of the investor 208. The investor 208's limit may also be set in accordance with a production history of the investor 208 or in accordance with a membership status of the investor 208. In this regard, the investors 208 may attain higher membership statuses based on a history, payment, or other means upon which an investor 208's maximum contribution amount may be increased.

After receiving a production plan for producing the creative work from the producer 206 at S702, the processor of the computer server 202 may offer the production plan for the creative work to the investors 208 at S704. The production plan includes the request for the capital for the production of the creative work. In this regard, the computer server 202 may offer any combination of the exemplary production plans shown in FIG. 10, FIG. 11, and FIG. 12, or offer any additional or alternative production plans, as the production plan via the network 212. Each of the investors 208 may access the production plan via the Web Portal 800 of FIG. 8, or via any additional web portals, applications, and/or programs.

The computer server 202 receives acceptances of the request for the capital from the investors 208 at S706. The acceptances may be received by the computer server 202 through the Web Portal 800 via the network 212. The acceptances include the capital that is requested for the production of the creative work. As discussed above, the amount of the capital may be predetermined and equal amongst each of the acceptances of the investors 208, or the acceptances may include user-selected or server-selected amounts which are unequal. In any event, the acceptances comprise the capital which is requested for the production of the creative work by the producer 206. In this regard, the capital is generally in the form of a monetary contribution. Nevertheless, any or all of the capital of each or all of the acceptances may comprise non-monetary capital, such as goods or services.

The acceptances of the request for the capital may include the actual exchange or transfer of money from the investors 208 to the computer server 202. The capital may be transferred from investor accounts with the computer server 202, or the capital may be transferred from external accounts, such as from a credit account via a credit card transaction or from an e-commerce account via an online money transfer. The transfer of the capital from the investors 208 to the computer server 202 should not be limited to the above-described examples, and any other known and understood methods of payment or money transfer may be used without departing from the scope of the present application. For example, the capital may be transferred to a holding or escrow account, whereupon it is conditionally or unconditionally distributed to the producer 206. The capital may even be transferred directly from the investors 208 to the producer 206 without involving the computer server 202 or any third-parties. In any event, via the acceptances of the production plan of the creative work by the investors 208, the investors 208 agree to contribute the requested capital which is necessary for the production of the creative work.

Upon or after receiving the acceptances, the capital is transferred from the investors 208 to the producer 206 for the production of the creative work at S708 of FIG. 7. The capital may be transferred by the computer server 202, by a third party, directly from the investors 208 to the producer 206, or by any additional or alternative means which are known and understood. The capital may be transferred upon receipt of all of the acceptances or upon pledging of the full amount of the request for the capital. In this regard, the computer server 202 or other entity may not actually transfer or take receipt of any capital from any of the investors 208 until the full amount of the request for the capital is pledged or contributed. Alternatively, the computer server 202 or other entity may accept the capital from each of the investors 208 as it is received and/or transfer the capital to the producer 206 as it is received. Of course, any known methods of capital exchange may be utilized by the computer server 202 without departing from the scope of the present application.

Upon receipt of the capital, the producer 206 may engage in the production of the creative work at 5710. The computer server 202 may be directly or indirectly involved in the production of the creative work. Alternatively, the computer server 202 may not be involved in the production of the creative work. The investors 208 may also be directly or indirectly involved in the production of the creative work, or the investors 208 may not be involved in the production of the creative work.

In embodiments of the Electronic Funding & Management function 526, the producer 206 of the creative work may be given unlimited artistic authority and creativity in producing the creative work. However, in further embodiments of the Electronic Funding & Management function 526, the producer 206 may be held to a schedule and/or the production plan. In this regard, the producer 206 may be required to meet deadlines during the production of the creative work in accordance with the production. The producer 206 may even be required to post or submit information to the computer server 202 which provides evidence of satisfactory completion of the creative work and/or the production plan. In the event that the producer 206 fails to complete the creative work and/or follow the production plan, fines or penalties may be levied against the producer 206. The fines or penalties may include monetary fines or penalties, or any additional types of penalties or fines such as, but not limited to, loss of distribution, ownership, or other rights in the creative work. The producer 206 may also receive negative ratings or reviews from the computer server 202 and/or the investors 208 for failing to complete or follow the creative work and/or the production plan.

Upon completion of the creative work, or even during intermittent stages of the creative work production process, the creative work may be made available via the computer server 202 at S712. In this regard, the creative work may be made available to the viewers through the Web Portal 800 as shown in FIG. 8. The creative work may be accessible and/or searchable via the Viewer Section 808. Of course, the creative work may be made available via additional or alternative channels as well.

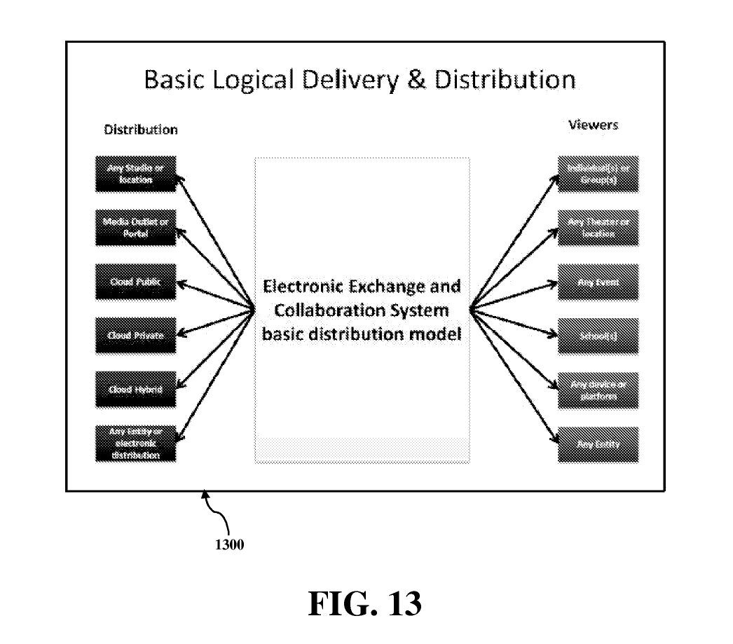

An exemplary Delivery any Distribution Setup is generally indicated at 1300 in FIG. 13. The Delivery any Distribution Setup 1300 shows a logical delivery, distribution, and sharing scheme of information between entities using the EECS 300. As shown in FIG. 13, the EECS 300 may distribute the creative work to any of the viewers or group of viewers. The EECS 300 may also distribute the creative work to theaters or locations which are registered or associated with the EECS 300, and may even further distribute the creative work to any events, schools, device, platforms, or any other entities which are registered or associated with the EECS 300. In even further combinations, the EECS 300 may distribute the creative work to the public. For example, as shown in FIG. 13, the EECS 300 may distribute the creative work to any studio or location, to any media outlet or portal, to any public cloud, to any private cloud, to any hybrid cloud, to any electronic distribution means, to any file sharing network 212s, and to any other entities.

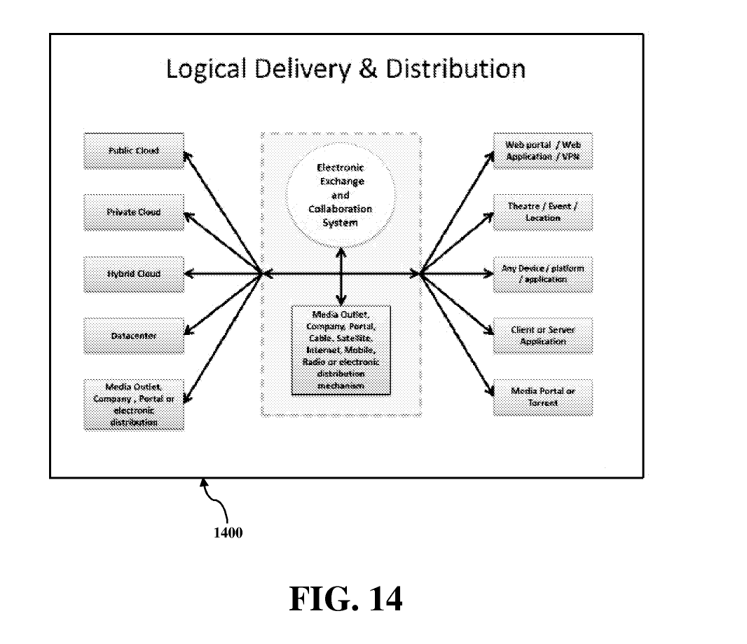

An additional exemplary Delivery and Distribution Setup is generally indicated at 1400 in FIG. 14. The Delivery and Distribution Setup 1400 of FIG. 14 further shows the logical delivery and distribution of all creative works and media between entities using the system. The EECS 300 can deliver the creative works and media to and from any location and any device or entity via the shown communication structure. The EECS 300 can deliver the creative works and media amongst the entities via an application programming interface (API), software development kit (SDK), plug-in, software, or device. The EECS 300 can deliver the content independently or via any other system or entity with which it interacts via any API, SDK, plug-in, software, or device. The creative works and content need not necessarily be delivered through the EECS 300. In embodiments of the present application, the content may be created, managed, and delivered from any other outlet, location, or entity for distribution. As shown in FIG. 14, the EECS 300 may have a one-to-one, one-to-many, or many-to-many distribution process depending on the requirements of any creative work or project. Of course, those of ordinary skill in the art appreciate that the Delivery and Distribution Setup 1300 of FIG. 13 and the Delivery and Distribution Setup 1400 of FIG. 14 are merely exemplary and are not limiting. Additional or alternative distribution schemes may be utilized by the EECS 300 without departing from the scope of the present application.

The creative work is generally made available to the viewers at S712 for generating revenue. The creative work may be made available by the computer server 202 through the Web Portal 800 via the network 212. A Logical Portal Process by which a viewer, or an investor 208, may access a creative work is generally indicated at 1500 of FIG. 15. The Logical Portal Process 1500 shows an exemplary process by which a viewer, or an investor 208, would access a creative work or content and make modifications or view the creative work or content. The Logical Portal Process 1500 also shows an exemplary process by which a producer 206 may access, produce, and distributes a creative work or content. Of course, the Logical Portal Process 1500 is merely exemplary and is not limiting. Additional or alternative portal processes may be available without departing from the scope of the present application.

The revenue may be generated by the creative work by any known and understood methods in the art. For example, the viewers may each pay a monthly subscription fee for using the EECS 300. In additional or alternative embodiments, the viewers may purchase individual licenses for creative works. The licenses may be for a single viewing, multi-viewings, specific durations, etc. The revenue may also be generated in accordance with any of the delivery and distribution means shown in FIG. 13 and FIG. 14 in addition to, or as an alternative to, the viewers. In this regard, any known and understood methods for generating revenue from a creative work may be employed by the EECS 300 without departing from the scope of the present application. The revenue may be generated and collected by the computer server 202, the producer 206, or any third party entity in accordance with known methods.

In embodiments of the Electronic Funding & Management function 526 of the EECS 300, the creative work may be provided to the investors 208 on a reduced cost basis or free of charge. FIG. 7 generally shows that the computer server 202 is caused to make the creative work available to each of the investors 208 at S714. The computer server 202 may make the creative work available to the investors 208 via the network 212, whereupon the investors 208 may access the creative work via the Web Portal 800.

Each of the investors 208 may be provided with viewing rights of the creative work for an unlimited duration, for a predetermined period of time, or for a predetermined number of times without charge after a release of the creative work. The investors 208 may also be provided with distribution rights and/or additional rights, such as ownership rights, in the creative work for an unlimited duration, for a predetermined period of time, or for a predetermined number of times. In even further embodiments of the Electronic Funding & Management function 526, the computer server 202 may make the creative work available to investors 208 during an introductory period in which the creative work is not available to the public. In other words, the computer server 202 may provide the investors 208 with access to a first showing of the creative work. As generally discussed above, the computer server 202 may provide the special viewing or other rights to the investors 208 on a reduced cost or no cost basis, or based on any additional or alternative special pricing basis or opportunities.

The computer server 202 receives and manages the revenue generated by the creative work at S716. The computer server 202 may be reasonable for the collection of the revenue as well, or the computer server 202 may receive that revenue from the producer 206 and/or a third party which distributes the creative work. The computer server 202 may manage the revenue generated by the creative work in a global account or in a specific account related particularly to the creative work. The revenue may be managed in a general account or in an escrow account. In this regard, those of ordinary skill in the art appreciate that the revenue may be managed in accordance with any known and understood financial practices without departing from the scope of the present application.

The revenue is distributed by the computer server 202 to the producer 206 and to the investors 208. In this regard, the producer 206 is provided with a system in which a creative work may be produced while obtaining financial assistance. The financial assistance may be entirely provided by the investors 208, or the financial assistance may be partially provided by the investors 208. In any event, the financial burden of producing the creative work by the producer 206 are minimized or eliminated. Nevertheless, the producer 206 is still able to realize a profit or expect compensation for the creative work. The investors 208 are also able to realize a profit or expect compensation for their contributions to the production of the creative work. In this regard, the investors 208 are able to receive royalty funding from the creative work while also experiencing a diminished or lessened financial burden for producing the creative work.

User profits may be paid via currency, credits, points or other financially rewarding system that can be converted into currency. User profits may also be combined with other forms of rewards that are non-monetary such as airline miles, other reward programs, gifts, tangible and non-tangible products or services. Of course, those of ordinary skill in the art appreciate that these example forms of payment are merely exemplary and are not limiting. The profits or royalty funding may be paid or issued in accordance with any known and understood methods.

Accordingly, the production of creative works is fostered while the investors 208 and the producers 206 are able to share in royalty funding. Moreover, the viewers 210 benefit through the production of well-funded creative works. In this regard, the creative works need not necessarily engage in advertising and mass marketing campaigns as the creative works are funded by the public, and thus, are likely to be promoted by the public.

The revenue may be distributed to the producer 206 and the investors 208 in accordance with various distribution schemes. In this regard, the revenue may be distributed equally amongst the producer 206 and the investors 208 in accordance with a uniform distribution scheme. In additional embodiments of the Electronic Funding & Management function 526, the revenue may be distributed amongst the producer 206 and the investors 208 in accordance with a priority or preference distribution scheme.

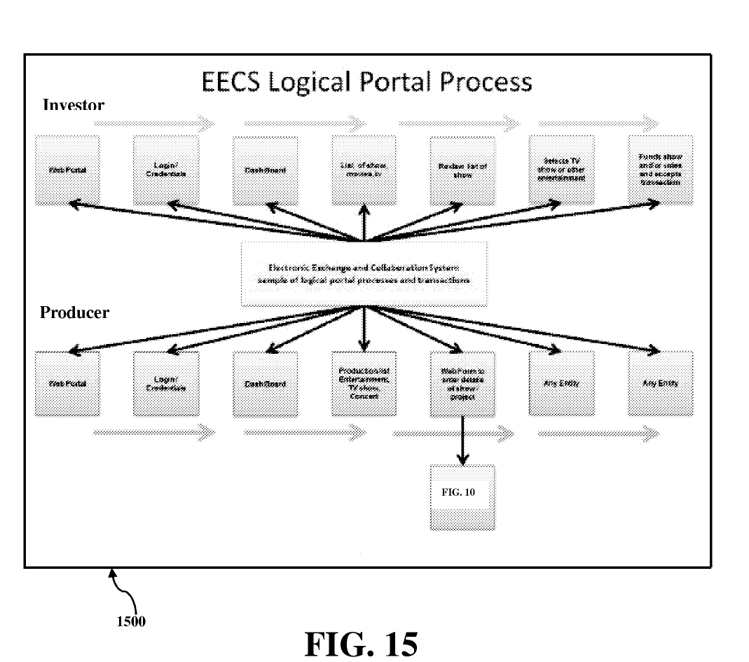

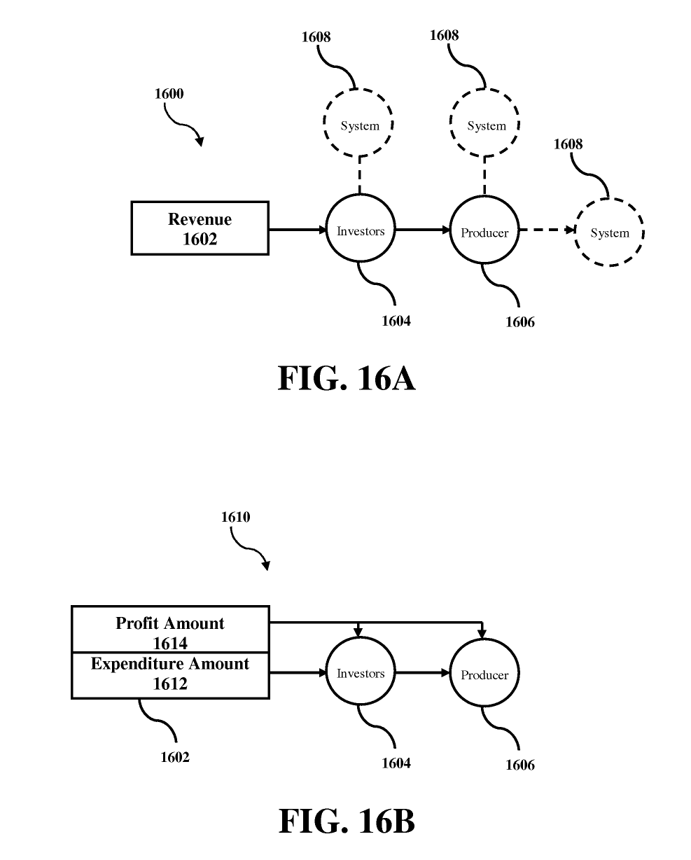

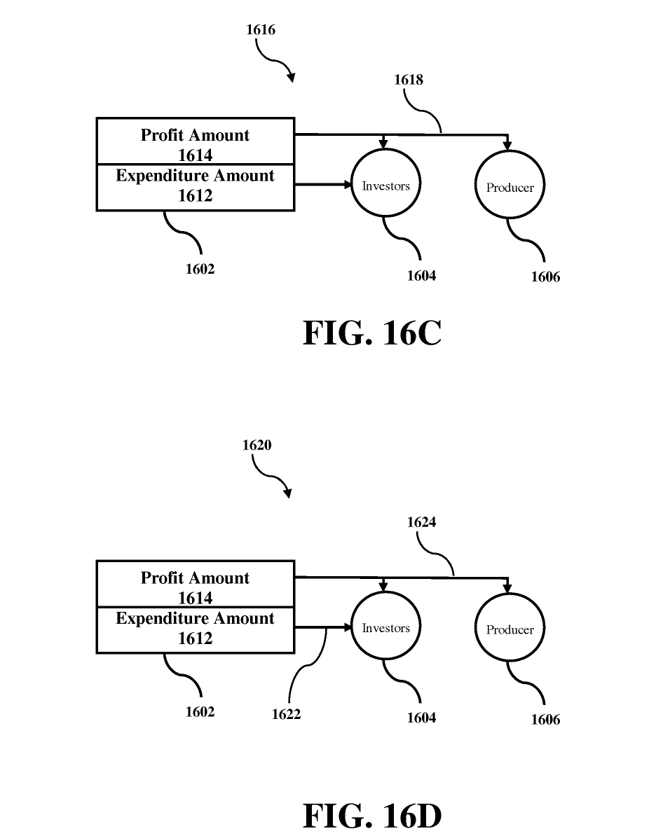

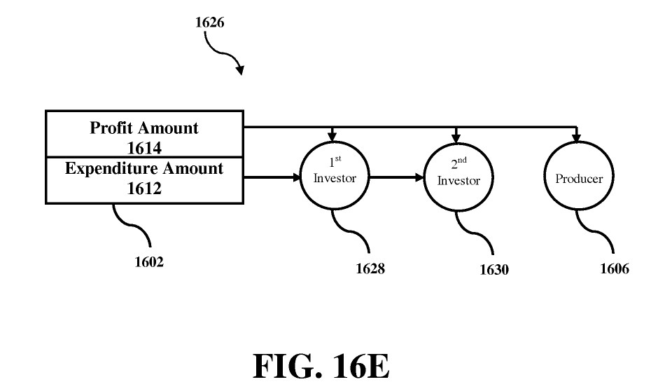

An exemplary embodiment of a priority distribution scheme of the Electronic Funding & Management function 526 is shown at 1600 in FIG. 16A. In this regard, revenue 1602 is distributed to investors 1604 in priority to a producer 1606 of a creative work. That is, the revenue 1602, or at least a portion thereof, may be distributed to the investors 1604 before the producer 1606. The revenue 1602, or at least a portion thereof, may additionally or alternatively be distributed to the investors 1604 at a higher percent than the producer 1606. In other words, the investors 1604 receive a benefit or priority to at least a portion of the revenue 1602 over the producer 1606.

The priority distribution scheme 1600 of FIG. 16A shows that the revenue 1602 may also be distributed to a system 1608 which operates the Electronic Funding & Management function 526, such as the EECS 300. In this regard, the revenue 1602 may be distributed to the system 1608 in priority to the producer 1606 of the creative work in addition to being distributed to the investors 1604 in priority. The priority distribution scheme 1600 may distribute the revenue 1602 to the system 1608 in correspondence with the investors 1604. For example, the system 1608 may receive a percentage of any distributions of the revenue 1602 to the investors 1604. Of course, those of ordinary skill in the art appreciate that the revenue 1602 may be distributed to the system 1608 in correspondence with the investors 1608 in accordance with any known methods, such as, but not limited to, a nominal amount or transaction fee being distribution to the system 1608 in correspondence with any distribution or distributions to the investors 1604.

In embodiments of the present application which are not shown by FIG. 16A, the priority distribution scheme 1600 may distribute the revenue 1602 to the investors 1604 in priority to the system 1608, or the priority distribution scheme 1600 may distribute the revenue 1602 to the system 1608 in priority to the investors 1604. According to such embodiments, the priority distribution scheme 1600 may elect to prioritize the reimbursement or making whole of the investors 1604 over the recoupment or capturing of any expenses or profit by the system 1608. Alternatively, the priority distribution scheme 1600 may elect to prioritize the capturing of any expenses or profit by the system 1608 over the reimbursement or making whole of the investors 1604.

The priority distribution scheme 1600 may additionally or alternatively distribute the revenue 1602 to the system 1608 in correspondence with the producer 1606. Once again, the priority distribution scheme 1600 may distribute the revenue 1602 to the producer 1606 in priority to the system 1608, or the priority distribution scheme 1600 may distribute the revenue 1602 to the system 1608 in priority to the producer 1606. According to such embodiments, the priority distribution scheme 1600 may elect to prioritize profiting by the producer 1606 over the recoupment or capturing of any expenses or profit by the system 1608. Alternatively, the priority distribution scheme 1600 may elect to prioritize capturing of any expenses or profit by the system 1608 over any profiting by the producer 1606.

In even further embodiments of the priority distribution scheme 1600, the priority distribution scheme 1600 may distribute the revenue 1604 to both the investors 1604 and the producer 1606 in priority to the system 1608. For example, the priority distribution scheme 1600 may reimburse each of the investors 1604 and reward the producer 1606, and possibly the investors 1604 as well, with a profit before distributing any of the revenue 1602 to the system 1608. The priority distribution scheme 1600 may reward either or both of the investors 1604 and the producer 1606 with a predetermined amount, such as a percentage of the requested capital, before distributing any revenue to the system 1608. The predetermined amount may be a percentage of the capital which is less than, equal to, or greater than the amount of the capital.

The above-listed embodiments of the priority distribution scheme 1600 with respect to at least the system 1608 are merely exemplary and are not limiting or exhaustive. In further embodiments of the priority distribution scheme 1600 of FIG. 16A or any of the other distribution schemes disclosed herein, those of ordinary skill in the art appreciate that the revenue 1602, or any portions thereof, may be distributed to the system 1608 in correspondence with, in priority to, or in reverse priority to either or both of the investors 1604 and the producer 1606 without departing from the scope of the present application. In even further embodiments, any fees, expenses, and/or profits of the system 1608 may be excluded from the revenue 1602. That is, the system 1608 may separately generate its own fees or costs through the distribution of the creative work, which are excluded and not considered a part of the revenue 1602 which is generated by the creative. For example, the system 1608 may accumulate a percentage of any total revenue generated by the creative work, whereby the revenue 1602 shown in FIG. 16A comprises the total revenue less any fees or costs accumulated by the system 1608. The system may accumulate a steady percentage of the total revenue, or the system 1608 may accumulate an increasing percentage of the total revenue. In this regard, various distribution schemes of the present application are discussed and shown with respect to FIGS. 16B-E without referencing the system 1608 or the total revenue generated by a creative work. Nevertheless, it is to be known and understood that the any funds or revenue may also be distributed to the system in accordance with any of the above-discussed methods or any other methods which are known and understood in the art.

A further exemplary embodiment of a priority distribution scheme of the Electronic Funding & Management function 526 is shown at 1610 in FIG. 16B. According to this embodiment, the revenue 1602 comprises an expenditure amount 1612 that is equal to the capital, which is used or expended to produce the production and which is included in the request. The revenue 1602 may further comprise a profit amount 1614 which is equal to any of the revenue 1602 which exceeds the expenditure amount 1612 or the capital. According to such an embodiment, the expenditure amount 1612 may comprise the portion of the revenue 1602 which is distributed to the investors 1604 in priority to the producer 1606 in accordance with the priority distribution scheme 1610. For example, the investors 1604 may receive a higher percentage of the expenditure amount 1612 than the producer 1606.

Additionally or alternatively, the investors 1604 may receive their contribution of the expenditure amount 1612 before the producer 1606. According to one embodiment of the priority distribution scheme of the Electronic Funding & Management function 526 which is generally shown at 1616 of FIG. 16C, the expenditure amount 1612 may be entirely distributed to the investors 1604 in priority to the producer 1606 by the priority distribution scheme 1618. In other words, the first revenue to come in from viewership fees, or otherwise, goes back to the investors 1604. Thereafter, any royalty funding or profit distribution amongst the investors 1604 and the producer 1606 goes into effect. According to such an embodiment, the investors 1604 may be effectually reimbursed for their initial contribution of the capital for the production of the creative work before the producer 1606 receives any royalty funding or return on his or her investment in the production of the creative work.

After the investors 1604 are reimbursed for their initial contribution, e.g., the expenditure amount 1610, any profit amount 1614 may be distributed amongst the investors 1604 and the producer 1606. The profit amount 1614 may be equally distributed amongst the investors 1604 and the producer 1606, or the profit amount 1614 may be unequally distributed amongst the investors 1604 and the producer 1606. That is, the profit amount 1614 may be distributed between the investors 1604 and the producer 1606 in a 50/50 split, or the profit amount 1614 may be distributed between the investors 1604 and the producer 1606 in an unequal split. The profit amount 1614 may also be distributed amongst the individual investors 1604 equally or unequally. For example, each of the investors 1604 may receive an equal share of the investor's portion of the profit amount 1614, or each of the investors 1604 may receive a share in accordance with his or her investment. A one dollar investment may provide a return proportionate to one dollar, while a one hundred dollar investment may provide a return proportionate to one hundred dollars. The return proportionate to one hundred dollars may be one hundred times as large as the return proportionate to one dollar. In this regard, the size of the return may increase linearly with the size of the investment, or the size of the return may increase exponentially with the size of the investment to encourage greater contributions. In this regard, according to an embodiment of a priority distribution scheme of the Electronic Funding & Management function 526 which is generally shown at 1620 of FIG. 16D, the expenditure amount 1612 may be distributed to the investors 1604 in priority to the producer 1606 in accordance with a first priority distribution scheme 1622, and the profit amount 1614 may be distributed to the investors 1604 in priority to the producer 1606 in accordance with a second priority distribution scheme 1624. The first priority distribution scheme 1622 may be any of the distribution schemes discussed above or discussed herein. The second priority distribution scheme 1624 may be the same or equal to the first priority distribution scheme 1622, or the second priority distribution scheme 1624 may be a different distribution scheme which is the same or equivalent to any of the distribution schemes discussed hereon. For example, the investors 1604 may receive 100% of the expenditure amount 1612 and 75% of the profit amount 1614.

An even further exemplary embodiment of a priority distribution scheme of the Electronic Funding & Management function 526 is shown at 1626 in FIG. 16E. In this regard, the expenditure amount 1612, or any portion of the revenue 1602, may be distributed to the investors 1604 in priority to the producer 1606 in accordance any of the priority distribution schemes discussed herein. The expenditure amount 1612, or any portion of the revenue 1602, may be even further distributed to the investors 1604 in accordance any of the distribution schemes discussed herein. For example, a first investor 1628 of the investors 1604 may receive the expenditure amount 1612, or any portion of the revenue 1602, in priority to a second investor 1630 of the investors 1604. The expenditure amount 1612, or any portion of the revenue 1602, may be distributed amongst the first investor 1628 and the second investor 1630 based on a timing of investment of the capital. In this regard, the expenditure amount 1612, or any portion of the revenue 1602, may be distributed amongst the investors 1604 in accordance with a first-in, first-out distribution scheme. Such an embodiment of the Electronic Funding & Management function 526 encourages early investment in the production of the creative work.

In even further embodiments of the priority distribution scheme 1626, the expenditure amount 1612, or any portion of the revenue 1602, may additionally or alternatively be distributed amongst the investors 1604 based on a percentage of the investment of the capital. The investors 1604 may even further exchange their royalty funding rights for additional privileges or rights. For example, the priority distribution scheme 1626 may include an option by which any investors 1604 may forego any distribution of the expenditure amount 1612, the profit amount 1614, or any combination thereof for viewing, distribution, or other rights in the creative work. These rights may include any right or combination of rights discussed herein.

For example, the second investor 1630 may exchange or reduce his or her right to a percentage or portion of the expenditure amount 1612, the profit amount 1614, or any combination thereof for viewing rights of the capital work for a predetermined number of times or a predetermined time period. Any of the investors 1604 may also forego or reduce any distribution rights of the expenditure amount 1612, the profit amount 1614, or any combination thereof for a predetermined period of time in exchange for predetermined rights in the creative work for the same predetermined period of time.

Additionally or alternatively to the above, the production plan for the creative work may include first and second requests for capital. In other words, the request for capital may comprise different types of requests. The acceptances from the funding users may comprise first acceptances of the first request and second acceptances of the second request. According to such an embodiment, the priority distribution scheme 1626 may distribute the expenditure amount 1612, the profit amount 1614, or any combination thereof to the first investor 1628 which sends the first acceptance of the first request for the capital in priority to the second investor 1630 which second the second acceptance of the second request for the capital. In this regard, the first and second requests may be distinguished in time or contribution amount. As a result, different levels of investors or different stages of investors may be established, whereupon the expenditure amount 1612, the profit amount 1614, or any combination thereof is distributed there amongst in accordance with a priority or preference scheme.

Of course, those of ordinary skill in the art appreciate that the priority distribution schemes discussed herein are merely exemplary and are not exclusive or exhaustive. Any additional or alternative distribution schemes may be used alone or in combination with the distribution schemes discussed herein without departing from the scope of the present application.

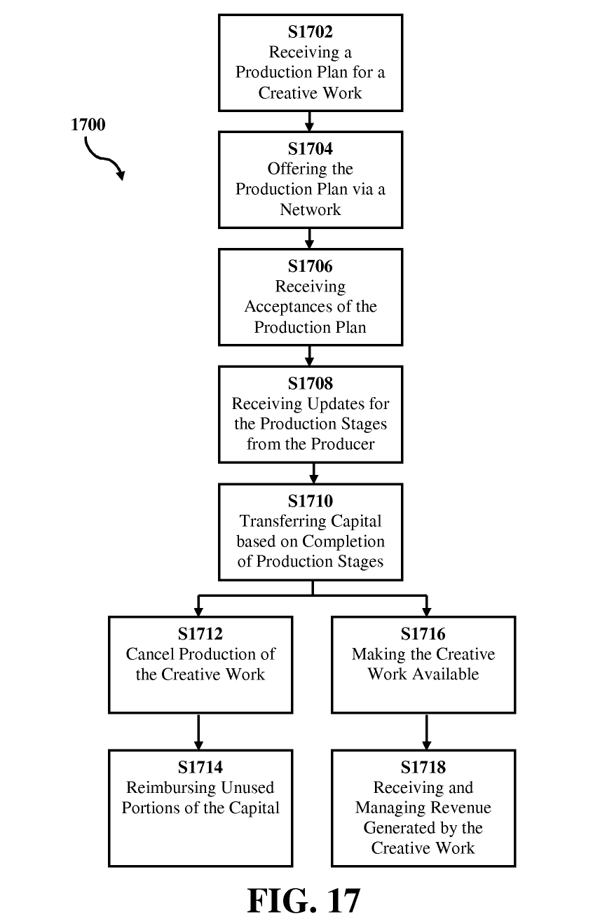

A further exemplary embodiment of the Electronic Funding & Management function 526 of the EECS 300 is generally shown in FIG. 17. The exemplary embodiment also includes operations for managing an exchange of capital between a producer 206 of a creative work and a plurality of investors 208. The operations are generally shown at 1700 in FIG. 17 and also may be managed by the computer server 202 as shown in FIG. 2. The computer server 202 receives a production plan for producing the creative work from the producer 206 at S1702. The production plan includes a request for the capital and further includes a plurality of production stages. Each of the production stages may be associated with a portion of the capital.

The computer server 202 offers the production plan at S1704, and receives acceptances of the request for the capital from the investors 208 at S1706. Thereafter, the computer server 202 receives updates for the production stages from the producer 206 at S1708. This enables both the computer server 202 and the investors 208 to monitor a production status of the creative work. The capital which is received with the acceptances is transferred to the producer 206 at S1710 in accordance with a completion of each of the production stages. In other words, the producer 206 receives the capital in increments to hold the producer 206 accountable for complying with the production schedule and limits the possibility for loss on account of an irresponsible producer 206. Moreover, the computer server 202 makes the updates for the production stages available to the investors 208 such that the investors 208 may monitor their investments. This provides the investors 208 with peace of mind and may also be beneficial in the event that additional capital is necessary from the investors 208.

In the event that the producer 206 fails to complete the production stages or the investors 208 are not satisfied with the updates provided by the producer 206, the computer server 202 and/or the investors 208 may cancel production at S1712. Each individual may cancel or withdrawn from the production process individually, or the investors 208 as a whole may agree to cancel the production process. The investors 208 may agree to cancel the production of the creative work as whole in accordance with any known procedures, such as but not limited to, a majority vote.

In the event that production of the creative work is cancelled at S1712, any unused portions of the revenue may be distributed to the investors 208 at S1714. The unused portions of the revenue may be returned to the investors 208 in accordance with any of the priority distribution schemes discussed herein, or the unused portions may be returned to the investors 208 on an equal basis. For example, the unused portion of the capital may be reimbursed to the investors 208 in accordance with a reimbursement priority scheme in which the unused portion of the capital is reimbursed to a first investor 208 in priority to a second investor 208. Such an embodiment would encourage and incentive early investing in creative works.

In the event that a single investor 208 cancels or withdraws from the production of the creative work, only his or her portion maybe returned at S1716. In any event, upon cancelling or withdrawn from production, the producer 206 may solicit additional investors 208 for continuing production of the creative work. In the event that the producer 206 is able to find additional investors 208, the production of the creative work may continue as planned.

Should the production of the creative work not be cancelled at S1712, the completed creative work is made available to the investors 208 and/or the viewers at S1716, and the computer server 202 receives and managing revenue generated by the creative work at S1718. The computer server 202 may receive and manage the revenue in accordance with any of the teachings described herein.

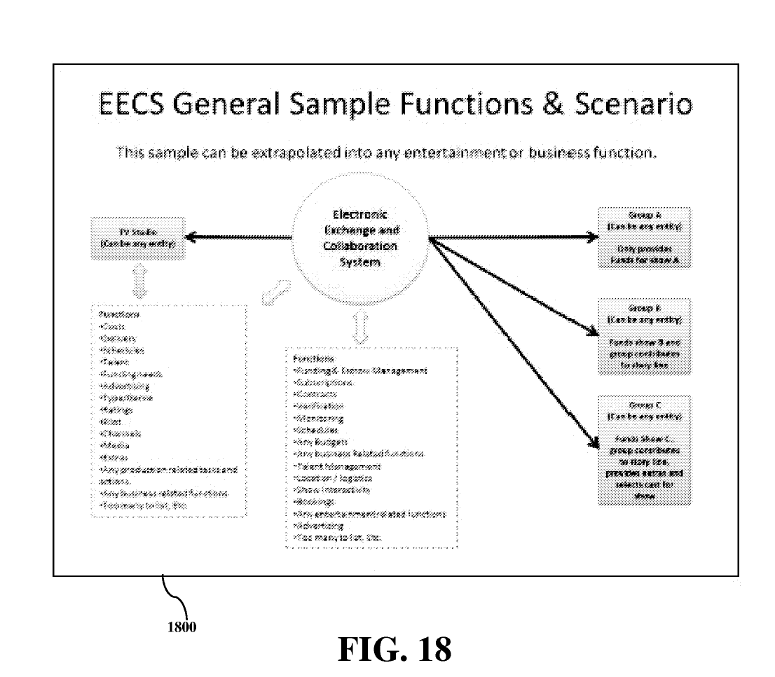

FIGS. 18-25 show additional aspects and schematics of the EECS 300. These aspects and schematics are shown and described to explain in further detail the EECS 300. Nevertheless, it is to be known and understood that these aspects and schematics are not limiting or exhaustive. The EECS 300 may include additional features without departing from the scope of the present application.

FIG. 18 shows a sample process for managing the exchange of capital between a producer 206 and a group of investors 208. A General Sample Functions & Scenario is shown at 1800. The General Sample Functions & Scenario shows in more detail some of the functionality between sample entities to demonstrate a basic funding, functionality, collaboration, and communication process. FIG. 18 lists exemplary functions which may be implemented by the EECS 300 and the producer 206 for producing the creative work. These exemplary functions are not limiting or exhaustive.

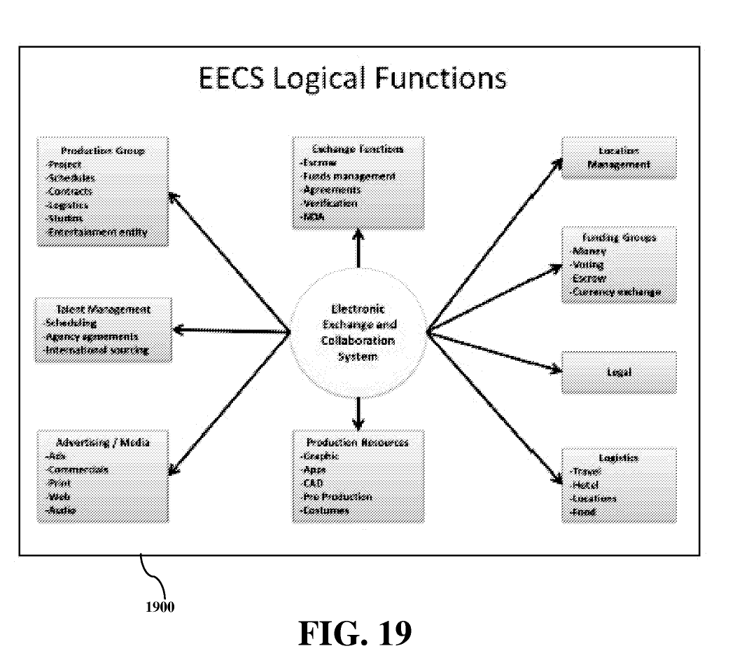

FIG. 19 generally shows Logical Functions window which may be implanted by the EECS 300 at 1900. These functions may be implemented by the EECS 300 in addition to or in conjunction with the E Electronic Funding & Management function 526. The Logical Functions window 1900 shows some of the logical functions that the EECS 300 processes as entities use the system. The Logical Functions window 1900 shows a basic modular, object data structure. The data structure is designed to function across any type of database or data management system that uses open source or proprietary code. These functions may be implemented by any known procedures in the art, and they should not be interpreted as being exclusive or exhaustive.

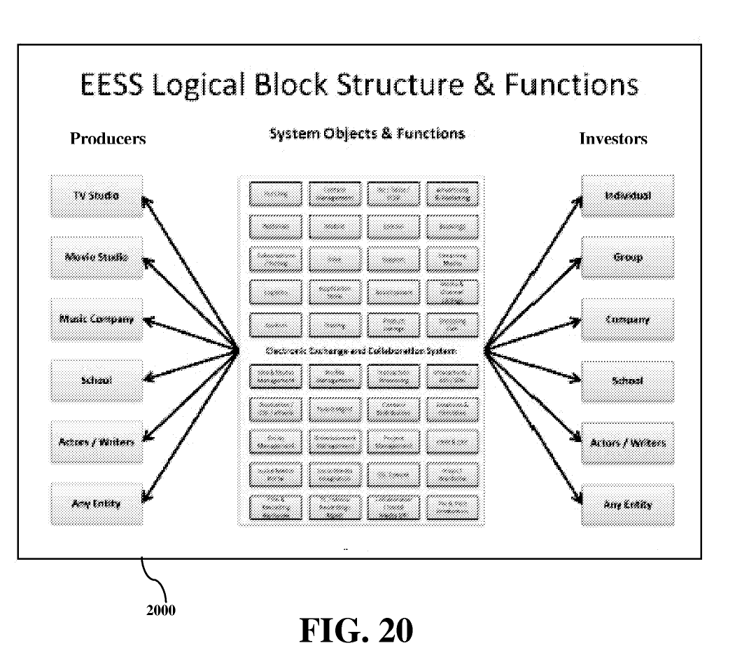

FIG. 20 further shows in more detail a Logical Block or Object Structure & Functions schematic for the EECS 300 at 2000. The Logical Block or Object Structure & Functions schematic 2000 shows some of the logical block or object and data functions that the EECS 300 processes between entities using the system. FIG. 20 also shows the modularity and object structure in order to have an elastic and scalable application and/or portal that can adapt to the changing needs and interactivity of entities using the system. In this regard, shown objects and functions may be implemented by the EECS 300 in accordance with any known and understood methods. Moreover, the shown objects and functions may be further implemented in accordance with specific methods according to the EECS 300. For example, FIG. 20 shows that the EECS 300 may include a customer relationship management (CRM) object.

The CRM object allows the EECS 300 to manage the users 204, producers 206, investors 208, and viewers 210 separately and/or collectively. The CRM object may monitor the projects, creative works, investments, viewing habits, or any additional activities of the users 204, producers 206, investors 208, and viewers 210. The activities may be monitored and tracked by the EECS 300 itself, or by any third party entity. In this regard, the priority schemes upon which the revenue is distributed to the producers 206 and the investors 208 may be determined by the activities. For example, investors 208 and/or producers 206 which more actively produce, invest, and/or view projects may have a higher priority over other investors 208 and/or producers 206 and/or receive a larger disbursement than other investors 208 and/or producers 206. More active investors 208 and/or producers 206 may also receive larger disbursements with respect to the EECS 300. That is, any fees, costs, or profits absorbed by the EECS 300 may be decreased for more active investors 208 and/or producers 206.

The CRM object may be implemented in conjunction with an enterprise resource planning (ERP) object. The ERP object may enable the EECS 300 to monitor its outstanding resources or the resources or commitments of any of the producers 206 and/or investors 208. In this regard, the priority distribution schemes may account for the outstanding resources or commitments of the producers 206 and investors 208 when distributing any revenue generated by a creative work. For example, the EECS 300 may distribute the revenue to investors 206 or producers 208 with greater outstanding obligations or commitments in priority to those investors 206 or producers 208 with less outstanding investments or commitments. Of course, these examples are merely exemplary and additional objects and functions may be implemented in accordance with the described features of the EECS 300 without departing from the scope of the present application. It should be known and understood that the block structure of FIG. 20 and the objects and functions shown therein are merely exemplary and are not limiting, exclusive, or exhaustive.

The EECS 300 also has the ability to integrate public and private cloud, commercial off the shelf desktops and operating systems or virtual desktops, commercial off the shelf or virtual applications and other virtual environments that allow producers of any sort to feed their works directly into the EECS 300 for development, collaboration, distribution, financing viewing and any other associated function within the EECS 300 to ensure a return to the works that were developed via the electronic means either within the system or adjunct to the EECS 300.

The EECS 300 also has functionality related to social media portals that allows the sharing of such royalty works once developed via or in conjunction with the EECS 300, to be used or collaborated in conjunction with an EECS social media portal or other portal in order to promote and/or generate other value which can be monetized. This functionality can facilitate logistics, distribution, collaboration and other unique functionality to such works that permit faster time to market with simpler and greater reach for consumers.

The EECS 300 functions have further adaptive capabilities for merchandising of the works that allow for deeper integration and collaboration. The merchandising functions allows for unique cross reward, subscription and monetization schemas allowing producers to have selective offerings and investors to have selective opportunities of offerings, of tangible and intangible products and services.

The EECS 300 block and object functions allow cross production, development, linking and reporting allowing all projects to blend resources between and across the EECS platform to use resources in all forms to accelerate project timelines and results. For example, Project A may have staff, merchandising and production resources that could be shared amongst Project B and Project C and vice versa. The unique mechanism that links all objects and functions creates a new form of system matrix allowing for a functional mechanism that cannot be solved by commercial off the shelf applications such as CRM's or ERP's but functions with a more complex matrix than standard CRM, ERP or Tier 1 type applications and products.

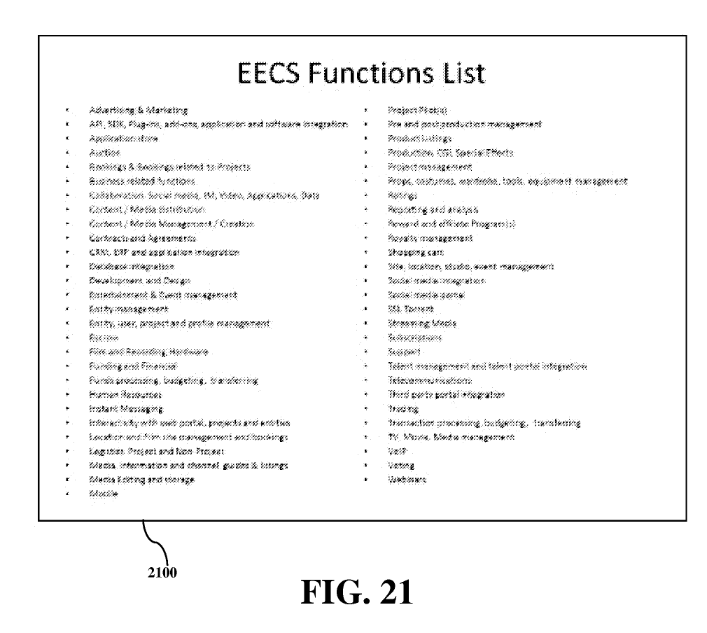

FIG. 21 shows an exemplary Functions List of the EECS 300 at 2100. The listed functions are merely exemplary and are not exclusive or exhaustive. For example, additional functions may include a scoring and probability index which indicates how well a television show or other entertainment has a chance to succeed based on past analysis. Additional functions may further include: viewership programming and controls; general programming and controls; listings; data mining and tracking; money exchange, transaction processing, payment processing, credits, cash, points that can be converted to different monetary systems, and exchanges or conversions; a for profit crowd funding systems for any conceivable project; transaction processing which covers any financial or monetary function the system may have including for profit payments or other exchanges to users who have funded projects or entertainment; data feeds, such as rich site summary (RSS) or push technology; disaster recovery; system to system synchronization; caching and system acceleration; quality-of-service (QOS) applications; and license programming and controls. Of course, these functions are again exemplary and not limiting or exhaustive.

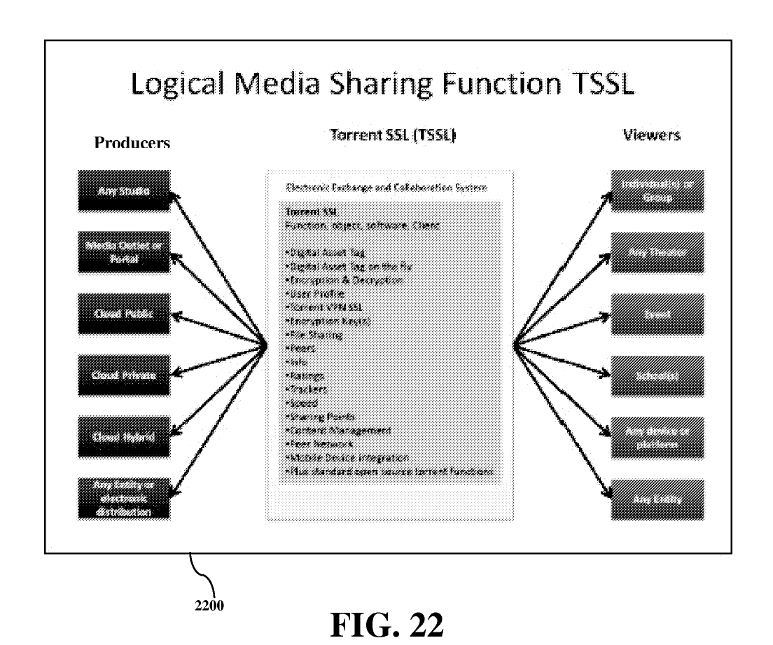

FIG. 22 shows an exemplary Logical Media Sharing Function Torrent Secure Socket Layer (TSSL) of the EECS 300 at 2200. The Logical Media Sharing Function TSSL 2200 is an application and/or interface that allows the viewer 210 to download, purchase, manage content, manage their profile, and view content while sharing their bandwidth with other users in order for other members to download content securely and much faster than a download from a single datacenter or location. Any such function may run in the Web Portal 800 or as application on any device. Those of ordinary skill in the art will appreciate that the function may include any of the functions of a standard torrent application, including the following: digital asset tag or digital marker; digital asset tag or digital marker on the fly; encryption; floating point encryption; subscription; Voice over Internet Protocol (VoIP); virtual private network (VPN); domain name server (DNS) management and proxy; collaboration; compression; QOS; proxy secure socket layer (SSL); caching; playback; streaming playback; content management; timing; bandwidth controls and metrics; media & transfer dashboards; reporting; user profile; torrent VPN SSL; encryption key(s); file sharing; peers; info; ratings; trackers; speed; sharing points; content management; peer network; mobile device integration and mobile application; and any standard open source torrent functions.

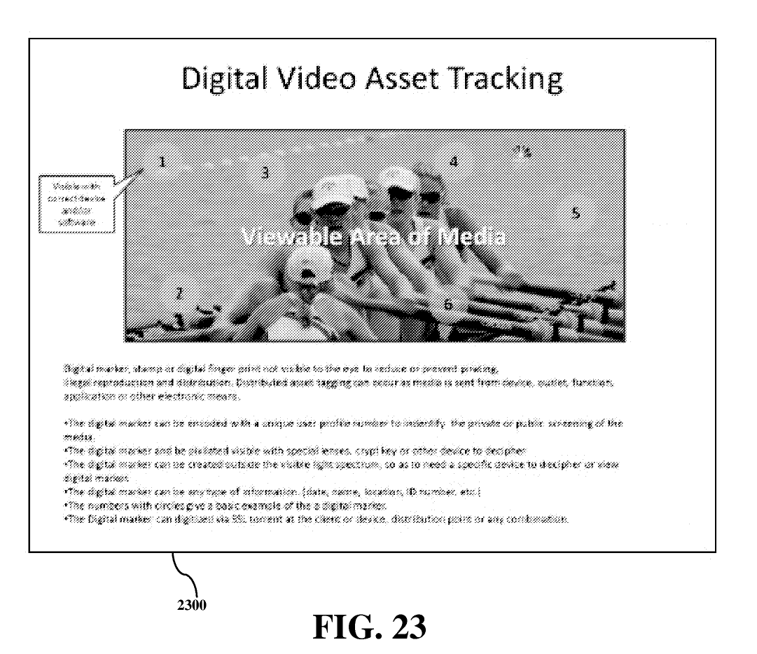

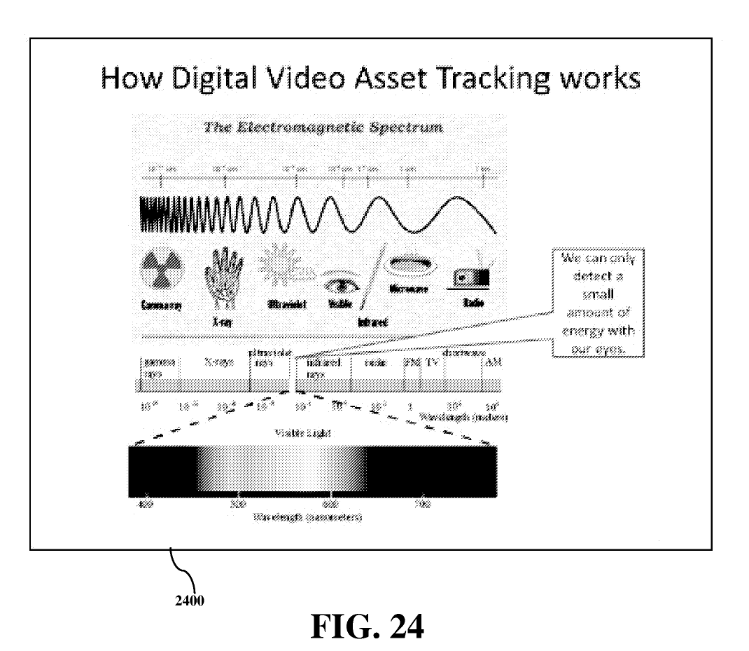

FIG. 23 and FIG. 24 show and explain exemplary Digital Video Asset Tracking processes at 2300 and 2400, respectively, which may be included within the EECS 300. Specifically, FIG. 23 and FIG. 24 show an example method by a digital marker, stamp or digital finger print not visible to the eye which may be used to reduce or prevent pirating, illegal reproduction and distribution. Such distributed asset marking or tagging can occur as media is sent from any of the electronic devices 204, 206, 208, 210, outlet, function, application or other electronic means. Any digital marker or tag may be created outside the visible light spectrum, so as to need a specific device to decipher or view the digital marker. Ina actuality, all forms of light and energy are part of the same phenomena: the electromagnetic spectrum. Our eyes can detect only a small amount of this energy, the portion we call “visible light.” Radio waves, X-rays, microwaves, gamma rays, and the rest all have longer or shorter wavelengths than visible light, but otherwise are the same phenomena. Since the visible light wavelength is so short, asset tracking makers could be imprinted into the creative works or media digitally allowing for the information to be invisible to the naked eye. This system can use a combination of visible and non-visible markers to achieve the asset tracking. The system can also use inconspicuous and visible markers to generate the asset tracking code. The technology can implemented via a series of devices working in conjunction such as microchips, software, monitors, televisions, displays, glass, bulbs and other spectrum producing mediums. A floating point stamp can be anything which is not directly related to cipher or stamp but references something that is fixed or not fixed in order to provide the asset tracking code. The floating point may include coordinates, a stars frequency, a stars or planets location in sky, or any other form that creates a floating point marker in addition to the cipher. In this regard, the above description is merely exemplary and any additional or alternative digital rights management (DRM) functions or methods may be incorporated into the EECS 300.

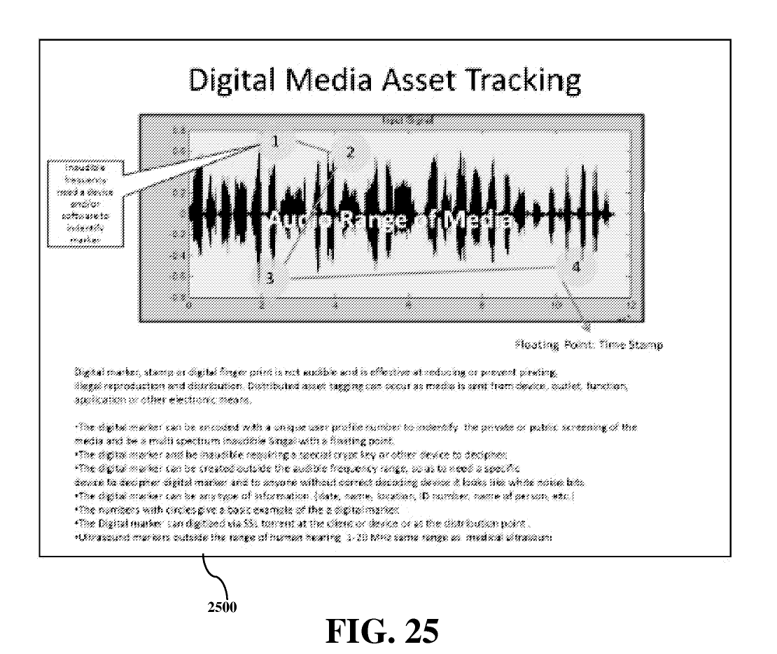

FIG. 25 shows an additional exemplary Digital Media Asset Tracking function at 2500 which may be included within the EECS 300. The Digital Media Asset Tracking function 2500 may include a floating point stamp. A floating point stamp may be anything which is not directly related to cipher or stamp but references something that is fixed or not fixed in order to provide the asset tracking code. The floating point may include coordinates, a stars frequency, a stars or planets location in sky, or any other form that creates a floating point marker additional to the cipher. The floating point marker may be splint in different sections of the cipher by making decryption without the floating point basically void. This system can use a combination of audible and non-audible markers to achieve the asset tracking. The system can also use inconspicuous and audible markers to generate the asset tracking code.

Of course, those skilled in the art appreciate that the above-described embodiments are merely exemplary and that the present disclosure includes various additional and alternative methods in accordance with the teachings and disclosure set forth herein. Moreover, those of ordinary skill in the art understand the various processes and methods described herein may be implemented by various computer programs and computer-readable media including executable instructions. The computer programs and computer-readable media, when executed, may implement any of the various processes, methods, or combinations thereof disclosed herein.

Accordingly, the present disclosure provides various systems, servers, methods, media, and programs for providing managing an exchange of capital between a producer of a creative work and a plurality of investors. Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A server for managing an exchange of capital between a producer of a creative work and a plurality of investors, the server comprising:
a network interface;
a processor; and
a memory including instructions that, when executed by the processor, cause the processor to execute operations comprising:
receiving a production plan for producing the creative work from the producer via the network interface, the production plan including a request for the capital;
offering the production plan including the request for the capital to the plurality of investors via the network interface;
receiving acceptances of the request for the capital from the plurality of investors via the network interface, the acceptances including the capital;
transferring the capital received from the plurality of investors to the producer for producing the creative work; and
receiving and managing revenue generated by the creative work, at least a portion of the revenue being distributed to the plurality of investors in priority to the producer in accordance with a priority distribution scheme.

2. The server according to claim 1, wherein:
the revenue comprises an expenditure amount equal to the capital and a profit amount equal to the revenue which exceeds the capital; and
the expenditure amount comprises the portion of the revenue which is distributed to the plurality of investors in priority to the producer in accordance with the priority distribution scheme.

3. The server according to claim 2, wherein the expenditure amount is entirely distributed to the plurality of investors in priority to the producer by the priority distribution scheme.

4. The server according to claim 3, wherein the priority distribution scheme is a first-in, first-out distribution scheme in which the expenditure amount is distributed to the plurality of investors in an order of the acceptances of the request for the capital.

5. The server according to claim 2, wherein the profit amount is distributed to the plurality of investors and the producer in accordance with a profit distribution scheme different than the priority distribution scheme.

6. The server according to claim 5, wherein the profit distribution scheme includes an option by which each of the plurality of investors may forego any distribution of the profit amount under the profit distribution scheme for a predetermined period of time in exchange for predetermined rights in the creative work.

7. The server according to claim 1, wherein:
the production plan for producing the creative work includes a plurality of production stages, each of the plurality of production stages being associated with a portion of the capital; and
the capital is transferred to the producer in accordance with a completion of each of the plurality of production stages.

8. The server according to claim 7, wherein the operations further comprise:
receiving updates for the plurality of production stages from the producer via the network interface;
making the updates for the plurality of production stages available to the plurality of investors via the network; and
reimbursing any unused portion of the capital of any unsatisfied investors in response to receiving a request from the unsatisfied investors.

9. The server according to claim 7, wherein the operations further comprise:
reimbursing any unused portion of the capital to the plurality of investors in response to a failure of the producer to complete one of the plurality of production stages.

10. The server according to claim 9, wherein the unused portion of the capital is reimbursed to the plurality of investors in accordance with a reimbursement priority scheme by which at least some of the unused portion of the capital is reimbursed to a first investor in priority to a second investor.

11. The server according to claim 1, wherein the production plan includes the request for the capital from a predetermined number of users, each of the predetermined number of users requested to contribute the capital in an equal amount.

12. The server according to claim 1, wherein:
the production plan includes the request for the capital for the creative work and further includes a second request for second capital for a plurality of creative works;
the acceptances from the plurality of investors comprise first acceptances of the request for the capital for the creative work and second acceptances of the second request for the second capital for the plurality of creative works; and
the priority scheme distributes the portion of the revenue to the plurality of investors from which second acceptances are received in priority to the plurality of investors from which the first acceptances are received.

13. The server according to claim 1, wherein the operations further comprise:
making the creative work available to the plurality of investors and to viewing users via the network interface for generating the revenue.

14. The server according to claim 13, wherein the creative work is made available to the plurality of investors for one of a predetermined period of time and a predetermined number of viewings via the network without charge after a release of the creative work.

15. A method for managing an exchange of capital between a producer of a creative work and a plurality of investors, the method comprising:
receiving, via a network interface, a production plan for producing the creative work from the producer, the production plan including a request for the capital;
offering, via the network interface, the production plan including the request for the capital to the plurality of investors;
receiving, via the network interface, acceptances of the request for the capital from the plurality of investors, the acceptances including the capital;
transferring the capital received from the plurality of investors to the producer for producing the creative work; and
receiving and managing, by a processor, revenue generated by the creative work, at least a portion of the revenue being distributed to the plurality of investors in priority to the producer in accordance with a priority scheme.

16. The method according to claim 15, wherein:
the revenue comprises an expenditure amount equal to the capital and a profit amount equal to the revenue which exceeds the capital; and
the expenditure amount comprises the portion of the revenue which is distributed to the plurality of investors in priority to the producer in accordance with the priority distribution scheme.

17. The method according to claim 16, wherein the expenditure amount is entirely distributed to the plurality of investors in priority to the producer by the priority distribution scheme.

18. A non-transitory computer readable medium including an executable set of instructions for managing an exchange of capital between a producer of a creative work and a plurality of investors that, when executed by a processor, causes the processor to execute operations comprising:
receiving a production plan for producing the creative work from the producer, the production plan including a request for the capital;
offering the production plan including the request for the capital to the plurality of investors;
receiving acceptances of the request for the capital from the plurality of investors, the acceptances including the capital;
transferring the capital received from the plurality of investors to the producer for producing the creative work; and
receiving and managing revenue generated by the creative work, at least a portion of the revenue being distributed to the plurality of investors in priority to the producer in accordance with a priority scheme.

19. The non-transitory computer readable medium according to claim 18, wherein:
the revenue comprises an expenditure amount equal to the capital and a profit amount equal to the revenue which exceeds the capital; and
the expenditure amount comprises the portion of the revenue which is distributed to the plurality of investors in priority to the producer in accordance with the priority distribution scheme.

20. The non-transitory computer readable medium according to claim 19, wherein the expenditure amount is entirely distributed to the plurality of investors in priority to the producer by the priority distribution scheme.
